(19) United States
(12) Patent Application Publication
(10) Pub. No.: US 2024/0212144 A1
(43) Pub. Date: Jun. 27, 2024

(54) APPARATUS AND METHOD OF DETERMINING A CONDITIONAL PROFILE ADJUSTMENT DATUM

(71) Applicant: KPN INNOVATIONS, LLC., LAKEWOOD, CO (US)

(72) Inventor: Kenneth Neumann, LAKEWOOD, CO (US)

(73) Assignee: KPN INNOVATIONS, LLC., LAKEWOOD, CO (US)

(21) Appl. No.: 18/426,102

(22) Filed: Jan. 29, 2024

Related U.S. Application Data
(63) Continuation-in-part of application No. 17/892,894, filed on Aug. 22, 2022.
Application No. 17/892,894 is a continuation-in-part of application No. 17/884,658, filed on Aug. 10, 2022, now Pat. No. 11,908,135.
Application No. 17/884,658 is a continuation of application No. 16/837,007, filed on Apr. 1, 2020, now Pat. No. 11,443,424.

(51) Int. Cl. G06T 7/00; G06N 5/04; G06N 20/00

(52) U.S. Cl. CPC G06T 7/0012; G06N 5/04; G06N 20/00; G06T 2207/20081; G06T 2207/30008; G06T 2207/30016; G06T 2207/30101

(57) ABSTRACT

An apparatus for determining a conditional profile adjustment datum may include at least a processor; and a memory connectively connected to the at least a processor, the memory containing instructions configuring the at least a processor to receive a first plurality of photographs related to a human subject; identify a first conditional indicator as a function of the first plurality of photographs and entries contained within an expert database; generate a first conditional profile by training a classifier on a training dataset including a plurality of example conditional indicators as inputs correlated to a plurality of example conditional profiles as outputs; and generating the first conditional profile as a function of the first conditional indicator using the trained classifier; determine a conditional profile adjustment datum as a function of the first conditional profile; and communicate the conditional profile adjustment datum to the human subject.

### CROSS-REFERENCE TO RELATED APPLICATION DATA

This application is a continuation-in-part of U.S. patent application Ser. No. 17/892,894 filed on Aug. 22, 2022, and entitled “ARTIFICIAL INTELLIGENCE METHODS AND SYSTEMS FOR ANALYZING IMAGERY,” which is a continuation-in-part of U.S. patent application Ser. No. 17/884,658 filed on Aug. 10, 2022, and entitled “ARTIFICIAL INTELLIGENCE METHODS AND SYSTEMS FOR ANALYZING IMAGERY,” which is a continuation of U.S. patent application Ser. No. 16/837,007 filed on Apr. 1, 2020, entitled “ARTIFICIAL INTELLIGENCE METHODS AND SYSTEMS FOR ANALYZING IMAGERY,” of which both are incorporated by reference in their entirety.

### FIELD OF THE INVENTION

The present invention generally relates to the field of artificial intelligence. In particular, the present invention is directed to apparatus and method of determining a conditional profile adjustment datum.

### BACKGROUND

Conditions can be hidden and remain undetected for years on end. This can be quite challenging for individuals, who cannot appropriately seek treatment and manage these hidden problems. This can be further frustrated by an inability to intervene and reverse disease early.

### SUMMARY OF THE DISCLOSURE

In an aspect, an apparatus for determining a conditional profile adjustment datum may include at least a processor; and a memory connectively connected to the at least a processor, the memory containing instructions configuring the at least a processor to receive a first plurality of photographs related to a human subject; identify a first conditional indicator as a function of the first plurality of photographs and entries contained within an expert database; generate a first conditional profile by training a classifier on a training dataset including a plurality of example conditional indicators as inputs correlated to a plurality of example conditional profiles as outputs; and generating the first conditional profile as a function of the first conditional indicator using the trained classifier; determine a conditional profile adjustment datum as a function of the first conditional profile; and communicate the conditional profile adjustment datum to the human subject.

In an aspect, a method of determining a conditional profile adjustment datum may include, using at least a processor, receiving a first plurality of photographs related to a human subject; using the at least a processor, identifying a first conditional indicator as a function of the first plurality of photographs and entries contained within an expert database; using the at least a processor, generating a first conditional profile by training a classifier on a training dataset including a plurality of example conditional indicators as inputs correlated to a plurality of example conditional profiles as outputs; and generating the first conditional profile as a function of the first conditional indicator using the trained classifier; using the at least a processor, determining a conditional profile adjustment datum as a function of the first conditional profile; and using the at least a processor, communicating the conditional profile adjustment datum to the human subject.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of an artificial intelligence system for analyzing imagery;

FIG. 2 is a block diagram illustrating an exemplary embodiment of an expert database;

FIG. 3 is a block diagram illustrating an exemplary embodiment of a user database;

FIG. 4 is a diagrammatic representation of aspects of determining a conditional status;

FIG. 5 is a box diagram of an exemplary machine learning model;

FIG. 6 is a diagram of an exemplary neural network;

FIG. 7 is a diagram of an exemplary neural network node;

FIG. 8 is a process flow diagram illustrating an exemplary embodiment of an artificial intelligence method of analyzing imagery;

FIG. 9 is a diagram depicting an exemplary method of method of determining a conditional profile adjustment datum; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to artificial intelligence systems and methods for analyzing imagery. In an embodiment, a computing device analyzes a plurality of photographs to identify conditional profiles of users. Conditional profiles are generated using a classification algorithm, and additional machine-learning processes.

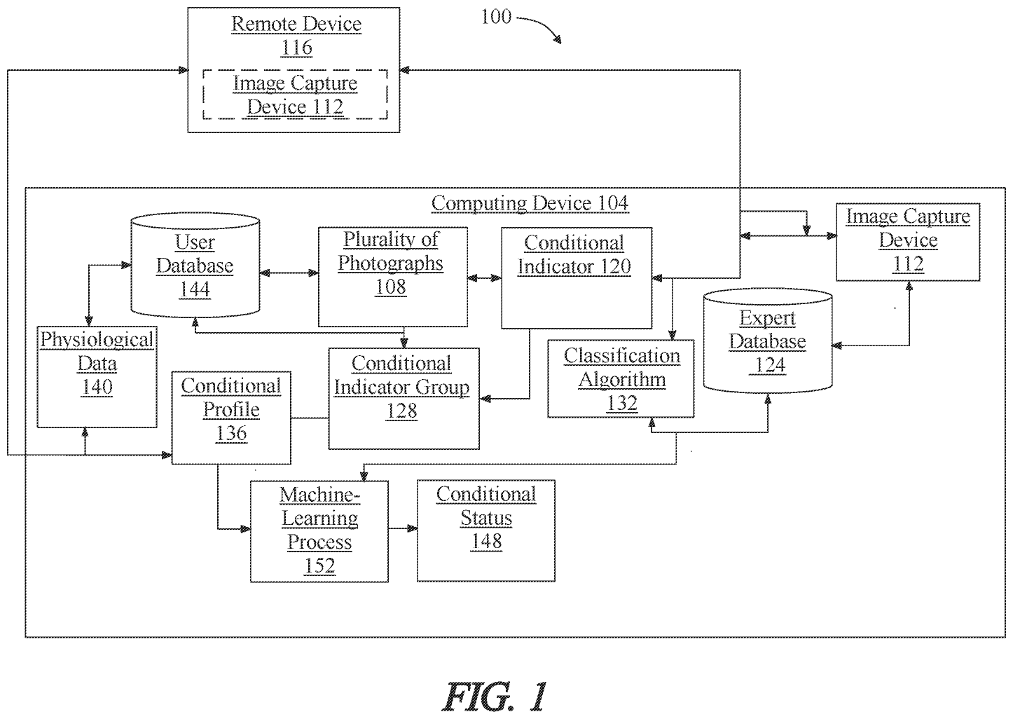

Referring now to FIG. 1, an exemplary embodiment of an artificial intelligence system 100 for analyzing imagery is illustrated. System 100 includes a computing device 104. Computing device 104 may include any computing device 104 as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently or may include two or more computing device 104 operating in concert, in parallel, sequentially or the like; two or more computing devices 104 may be included together in a single computing device 104 or in two or more computing devices 104. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices 104, and any combinations thereof. A network may employ a wired and/or a wireless mode of communication. In general, any network topology may be used. Information (e.g., data, software etc.) may be communicated to and/or from a computer and/or a computing device 104. Computing device 104 may include but is not limited to, for example, a computing device 104 or cluster of computing devices 104 in a first location and a second computing device 104 or cluster of computing devices 104 in a second location. Computing device 104 may include one or more computing devices 104 dedicated to data storage, security, distribution of traffic for load balancing, and the like. Computing device 104 may distribute one or more computing tasks as described below across a plurality of computing devices 104 of computing device 104, which may operate in parallel, in series, redundantly, or in any other manner used for distribution of tasks or memory between computing devices 104. Computing device 104 may be implemented using a “shared nothing” architecture in which data is cached at the worker, in an embodiment, this may enable scalability of system 100 and/or computing device 104.

Continuing to refer to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 is configured to receive a plurality of photographs 108 relating to a human subject. A “photograph,” as used in this disclosure, is an image created by light falling on a photosensitive surface. A photosensitive surface may include photograph film, an electronic image sensor such as a charge-coupled device (CCD), and/or an electronic image sensor such as a complementary metal oxide semiconductor (CMOS) chip. A photograph may be created using a camera. A “camera,” as used in this disclosure, is an optical instrument used to record images. A camera may include for example, a single-lens reflex (SLR) camera, a large format camera, a medium format camera, a compact camera, a rangefinder camera, a motion picture camera, a digital camera, and the like.

With continued reference to FIG. 1, computing device 104 is configured to receive from an image capture device 112 located on computing device 104, a wireless transmission from a remote device containing a plurality of photographs 108 related to a human subject. An “image capture device,” as used in this disclosure, is any device suitable to take a photograph and/or video of a human subject. Image capture device 112 may include for example, a camera, a mobile phone camera, a scanner, and the like. A “human subject,” as used in this disclosure, includes any user of system 100. A remote device 116, may include without limitation, a display in communication with computing device 104, where a display may include any display as described herein. Remote device 116 may include an additional computing device, such as a mobile device, laptop, desktop, computer and the like. In an embodiment, image capture device 112 may be located on a remote device 116 operated by a human subject, such as a camera located on a remote device 116 such as a mobile phone or laptop. In such an instance, a user may take a plurality of photographs 108 utilizing a remote device 116. In an embodiment, a third-party, such as a family member, friend, spouse, co-worker, and/or acquittance of the user may take one or more photographs of the user utilizing a remote device 116. For example, a user's boyfriend may take a series of photographs of the user utilizing an image capture device 112 such as a camera located on the user's mobile phone. Image capture device located on computing device 104 may receive a wireless transmission from a remote device 116 containing a plurality of photographs 108 related to a human subject utilizing any network methodology as described herein.

With continued reference to FIG. 1, a photograph may be related to a human subject when the photograph contains an image of the human subject. For example, a photograph may contain an image of a user's entire body, or an image of certain parts of a user's body such as an image of the user from the head and up. A photograph may be related to a human subject when the photograph was taken by the human subject. For example, a photograph taken by a user showing the inside of the user's kitchen is related to the human subject. In yet another non-limiting example, a photograph taken by a user showing several of the user's friends is related to the human subject. A photograph may be related to a human subject when the photograph contains an image showing any property owned and/or operated by the human subject. For example, a photograph may be related to a user when the photograph shows an image of a house or dwelling that the user lives in. In yet another non-limiting example, a photograph may be related to a human subject when the photograph contains an image showing any food, nutrition, and/or supplements intended to be consumed and/or ingested by a human subject. For instance and without limitation, a photograph may contain an image of a meal a human subject cooked at home and intends to consume. In yet another non-limiting example, a photograph may contain an image of a meal that a user ordered from a restaurant. A photograph may be related to a human subject when the photograph contains an image showing a social event and/or social activity that a user participates in. For instance and without limitation, a photograph may contain an image showing a user participating in a group fitness class or partaking in a hobby such as knitting. In yet another non-limiting example, a photograph may contain an image of one or more materials that a user may use to participate in a hobby such as a photograph containing an image of a bike that the user utilizes to go on bike rides.

With continued reference to FIG. 1, computing device 104 is configured to receive a plurality of photographs 108 related to the human subject. In some embodiments, plurality of photographs may be received from a social networking platform. In some embodiments, plurality of photographs 108 may be received from a computing device associated with a social networking platform. A “social networking platform,” as used in this disclosure, is a website, application, or both that enables a user to create content, share content, participate in social networking, or a combination thereof. A social networking platform may include computer-mediated technologies that facilitate the creation or sharing of information, ideas, career interests and other forms of expression through virtual communities and networks. A social networking platform may contain user-generated content such as text posts, comments, photographs, videos, and/or data generated through online interactions. A social networking platform may allow a user to create an individual profile that identifies background demographic information about the user, such as for example the user's name, neighborhood where the user lives, highest education that the user has achieved, work and/or employment history, marital status, reviews of the user by third parties such as friends, colleagues, neighbors and the like. For instance, and without limitation, a social networking platform may include an application such as but not limited to, FACEBOOK, INC. of Menlo Park, California; YOUTUBE of San Bruno, California; WHATSAPP of Menlo Park, California; INSTAGRAM of Menlo Park, California; TIKTOK of Shanghai, China; TWITTER of San Francisco, California; LINKEDIN of Sunnyvale, California; SNAPCHAT of Santa Monica, California; PINTEREST of San Francisco, California and the like. Computing device 104 may receive a plurality of photographs 108 from a social networking platform utilizing any network methodology and/or network transmission as described herein. In an embodiment, computing device 104 may extract a plurality of photographs 108 pertaining to a user from one or more social networking platforms utilizing any data scraping techniques. Data scraping may include extracting data from human-readable output coming from another program. In an embodiment, computing device 104 may scrape data from one or more websites, utilizing a web scraper such as an application programming interface (API). An API includes any computing interface to a software component or a system that defines how other components and/or other systems can use it. An API may define different kinds calls or requests that can be made, how to make them, data formats that should be used, conventions to follow and the like. An API may also include extension mechanisms so that users can extend existing functionality in various ways and to varying degrees. An API may be customized, and/or designed based on an industry standard to ensure interoperability. In an embodiment, an API may allow for the combination of multiple APIs into a new application known as mashups, which may facilitate the sharing of content and data between communities and applications. A web scraper may contain data feeds from web servers such as JavaScript Object Notation (JSON) that may be used as a transport storage mechanism between a computing device 104 and a webserver. A web scraper may utilize one or more techniques in document object model (DOM) parsing, computer vision, and/or natural language processing to simulate human processing that occurs when viewing a webpage to extract useful and/or meaningful information. In an embodiment, computing device 104 may receive a plurality of photographs 108 related to a human subject from a social networking platform based on one or more permissions controlled by the human subject. For instance and without limitation, the human subject may allow computing device 104 to retrieve photographs from a first social networking platform but not a second social networking platform. In yet another non-limiting example, a user may allow computing device 104 to retrieve photographs from a first social networking platform between a certain time period, such as between May through August during a certain year, or only during a specific year such as during the year 2019. In some embodiments, a plurality of photographs is received from a computing device associated with a social networking platform.

With continued reference to FIG. 1, computing device 104 is configured to receive a plurality of photographs 108 related to the human subject from a metaverse. As used in this disclosure, a “metaverse” is a simulated digital environment which uses virtual reality or augmented reality to create a space for user interaction imitating the real world. In some embodiments, the metaverse may use concepts from social media. Social media concepts may include computer based technologies that facilitate the sharing of information, ideas and thoughts through virtual networks and communities. The metaverse may allow users to interact with a computer-generated environment and other users. For example, the metaverse may provide the computing device with a plurality of photographs, videos, avatars and the like. Other non-limiting examples of sources of plurality of photographs 108 include a database, a camera of a human subject, a smartphone of a human subject, a website associated with a human subject, a profile picture of an account associated with a human subject, and the like. In some embodiments, a plurality of photographs is received from a computing device associated with a metaverse.

Still referring to FIG. 1, in some embodiments, a plurality of photographs 108 may be obtained using a web crawler. A web crawler may be configured to automatically search and collect photographs and/or other information related to a human subject. As used herein, a “web crawler” is a program that systematically browses the internet for the purpose of web indexing. The web crawler may be seeded with platform URLs, wherein the crawler may then visit the next related URL, retrieve the content, index the content, and/or measures the relevance of the content to the topic of interest. In one embodiment, the web crawler may be configured to scrape plurality of photographs 108 from user related social media and networking platforms. The web crawler may be trained with information received from a user through a user interface. As a non-limiting example, a user may input into a user interface, social media platforms they have accounts on and would like to retrieve user data from. A user interface may include a graphical user interface (GUI), command line interface (CLI), menu-driven user interface, touch user interface, voice user interface (VUI), form-based user interface, and the like. Computing device may receive plurality of photographs 108 including information such as a user's name, user's profile, platform handles, platforms associated with the user, social media accounts, metaverse accounts, data which may be used to verify data input by a user and the like. In some embodiments, a web crawler may be configured to generate a web query. A web query may include search criteria. Search criteria may include photos, videos, audio, user account handles, web page addresses and the like received from the user. A web crawler function may be configured to search for and/or detect one or more data patterns. A “data pattern” as used in this disclosure is any repeating forms of information. A data pattern may include, but is not limited to, features, phrases, and the like as described further below in this disclosure.

Still referring to FIG. 1, in some embodiments, a web crawler may work in tandem with a program designed to interpret information retrieved using a web crawler. As a non-limiting example, a machine learning model may be used to generate a new query as a function of prior search results. As another non-limiting example, data may be processed into another form, such as by using optical character recognition to interpret images of text. In some embodiments, a web crawler may be configured to determine the relevancy of a data pattern. Relevancy may be determined by a relevancy score. A relevancy score may be automatically generated by computing device, received from a machine learning model, and/or received from a user. In some embodiments, a relevancy score may include a range of numerical values that may correspond to a relevancy strength of data received from a web crawler function. As a non-limiting example, a web crawler function may search the Internet for data related to photographs associated with a user. In some embodiments, computing device may determine a relevancy score of plurality of photographs 108 retrieved by a web crawler.

Still referring to FIG. 1, metaverse input may produce, in some embodiments, one or more additional channels and/or signals of information. Multiple channels or signals may represent 3 or more dimensions of information in contrast to 2 dimensions available in a traditional image or photograph. The variation of 1 or more dimensions may identify health problems in a human subject or verify a conclusion. The data from the metaverse inputs are processed through the neural network to generate a conditional profile, which as used in this disclosure, is data including any numerical, character, and/or symbolic data describing the overall health and/or well-being of a human subject.

Still referring to FIG. 1, in some cases, computing device is configured to receive at least an image capture device located on computing device, a wireless transmission from a remote device containing a plurality of video elements related to a human subject. As used in this disclosure, “video elements” embed video resources in a document. For example, in some cases, image component may include an image of subject. As used in this disclosure, an “image component” is a visual representation of information, such as a plurality of temporally sequential frames and/or pictures, related to video input obtained from the metaverse. For example, image component may include animations, still imagery, recorded video, and the like.

Still referring to FIG. 1, the video may be communicated by way of digital signals, for example between computing devices which are communicatively connected with at least a wireless network. Digital video may be compressed to optimize speed and/or cost of transmission of video. Videos may be compressed according to a video compression coding format (i.e., codec). Exemplary video compression codecs include H.26x codecs, MPEG formats, VVC, SVT-AV1, and the like. In some cases, compression of a digital video may be lossy, in which some information may be lost during compression. Alternatively, or additionally, in some cases, compression of a digital video may be substantially lossless, where substantially no information is lost during compression.

Still referring to FIG. 1, High Efficiency Video Coding (HEVC), also known as H.265 and MPEG-H Part 2, is a video compression standard designed as part of the MPEG-H project as a successor to the widely used Advanced Video Coding (AVC, H.264, or MPEG-4 Part 10). In comparison to AVC, HEVC offers from 25% to 50% better data compression at the same level of video quality, or substantially improved video quality at the same bit rate. It may support resolutions up to 8192×4320, including 8K UHD, and unlike the primarily 8-bit AVC, HEVC's higher fidelity Main 10 profile may be incorporated into nearly all supporting hardware. While AVC may use the integer discrete cosine transform (DCT) with 4×4 and 8×8 block sizes, HEVC may use integer DCT and DST may transform with varied block sizes between 4×4 and 32×32. The High Efficiency Image Format (HEIF) may be based on HEVC.

Still referring to FIG. 1, the video may be representative of subject-specific data. As used in this disclosure, “subject-specific data” is any element of information that is associated with a specific subject. Exemplary forms of subject-specific data include image component, videos, non-verbal content, verbal content, audio component, as well as any information derived directly or indirectly from videos or any other subject-specific data. For example, subject-specific data could be the physical properties of the human subject, such as their body posture or facial expression. Subject-specific data could also be audio sensory properties of subject, such as tone of voice or background audio in a video. For example, a video may depict the human subject holding a can of beer while walking in a staggered manner which would lead to a conclusion that the human subject is impaired due to alcohol consumption.

Still referring to FIG. 1, in some cases, the video may include non-verbal content. As used in this disclosure, “non-verbal content” is all communication that is not characterized as verbal content. As used in this disclosure, “verbal content” is comprehensible language-based communication. For example, verbal content may include “visual verbal content” which is literal and/or written verbal content. Non-verbal content includes all forms of communication which are not conveyed with use of language. Exemplary non-verbal content may include change in intonation and/or stress in a speaker's voice, expression of emotion, and the like. For example, in some cases, non-verbal content may include visual non-verbal content. As used in this disclosure, “visual non-verbal content” is non-verbal content that is visually represented. For example, a video may depict the human subject at a party and standing and eating at the snack table the entire time, this may determine a conclusion of a risk of obesity for the user.

Still referring to FIG. 1, in some cases, a non-verbal classifier may classify non-verbal content present in one or more image component to one or more of video, a feature. Non-verbal classifier may include a number of classifiers, for example each being tasked with classifying a particular attribute or form of non-verbal content. For example, in some cases, non-verbal classifier may classify a video and human subject as associated with a feature representative of ‘happy.’ Non-verbal classifier may include another specialized visual non-verbal classifier to classify visual non-verbal content as appearing ‘happy’ that is, for example, as having appropriate posture, facial expressions, manner of dress, and the like.

Still referring to FIG. 1, in some embodiments, image component may include or otherwise represent audible verbal content related to at least an attribute of human subject. As used in this disclosure, “audible verbal content” is oral verbal content. Audible verbal content may include spoken content. In some cases, audible verbal content may be included within a video by way of an audio component. As used in this disclosure, an “audio component” is a representation of audio, for example a sound, a speech, and the like. In some cases, verbal content may be related to at least an attribute of human subject. Additionally, or alternatively, visual verbal content and audible verbal content may be used as inputs to classifiers as described throughout this disclosure. For example, a video may contain audio verbal content of a human subject speaking in a slurred way indicating an impairment.

With continued reference to FIG. 1, computing device 104 is configured to analyze a plurality of photographs 108 to identify a conditional indicator 120 contained within the plurality of photographs 108. A “conditional indicator,” as used in this disclosure, is a determinant of a user's health. Conditional indicator may be any determinant of the user's health. A “determinant of health,” as used herein, is a factor that impacts a person's health and wellness. determinant may include any factor that can have an impact on one's health and wellness. A determinant of health may include factors such as where a user lives, the state of a user's home environment, genetics, income, education level, social relationships with family, friends, acquaintances and the like, race, gender, age, nutrition, social status community involvement and/or engagement, major life events, physical activity levels, smoking status, alcohol and drug use, access to healthcare, health behaviors, and the like. For instance, and without limitation, a conditional indicator 120 may identify one or more determinants of health contained within an image, such as a photograph that contains an image of a user smoking cigarettes and drinking alcohol. In yet another non-limiting example, a conditional indicator 120 may reveal if a user is surrounded by other people in any photographs, such as if the user is pictured in a circle of friends or if they are routinely pictured being alone. A conditional indicator 120 may identify any nutritional behaviors and/or eating patterns of a user. For example, a conditional indicator 120 may identify different types of food, and/or nutrients that a user consumes, such as a plurality of photographs 108 that show that the user frequently cats meals from fast food restaurants that contain very few if any vegetables. A conditional indicator 120 may identify nutritional behaviors such as if a user routinely cooks meals at home, orders food to go from restaurants, and/or cats meals at restaurants. A conditional indicator 120 may indicate one or more social habits and/or factors pertaining to a user, such as if a user is a member of a church or religious organization, if a user participates in social activities with friends and the like. A conditional indicator 120 may indicate one or more fitness habits of a user, such as if a user is pictured engaging in physical activity such as by running or lifting weights. A conditional indicator 120 may identify one or more social determinants of a user's health, such as the user's age, race, and/or gender. A conditional indicator 120 may identify one or more behavior characteristics of a user, such as any photographs that contain an image of the user may reflect if the user is smiling or posing happily and for the camera, which may indicate that the person is extroverted and socially connected, while an image of the user who is hiding from the camera may indicate that the user is shy and introverted. A conditional indicator may indicate one or more internal determinants of a user's health. For example, a conditional indicator that reflects a user who frequently within a plurality of photographs 108 has pale skin and bags under the user's eyes may be suffering from a medical condition such as fatigue and/or anemia. In yet another non-limiting example, a user with cracks in corner of the user's lips may be suffering from a Vitamin B deficiency.

With continued reference to FIG. 1, computing device 104 may identify one or more conditional indicator 120 contained within a plurality of photographs 108 based on expert input. One or more experts may provide input that may be stored within expert database 124. Expert database 124 may include any data structure for ordered storage and retrieval of data, which may be implemented as a hardware or software module. An expert database 124 may be implemented, without limitation, as a relational database, a key-value retrieval datastore such as a NOSQL database, or any other format or structure for use as a datastore that a person skilled in the art would recognize as suitable upon review of the entirety of this disclosure.

With continued reference to FIG. 1, computing device 104 is configured to identify a conditional indicator group 128 identified within a plurality of photographs 108. A “conditional indicator group,” as used in this disclosure, is any determinant of health that has a shared commonality and/or any determinant of health that is repeatedly contained within the plurality of photographs. A determinant of health may have a shared commonality when the determinant of health may have a common root cause, or when two or more conditional indicator 120 may contribute to the same determinant of health. For instance and without limitation, a first conditional indicator 120 such as alcohol use, and a second conditional indicator 120 such as marital status may both relate to a conditional indicator group 128 such as social determinants of health. In yet another non-limiting example, a first conditional indicator 120 such as cooking habits and a second conditional indicator 120 such as recent meals consumed by a user, and a third condition indicator such as supplements consumed by a user, may all relate to a conditional indicator group 128 of nutritional determinants of health. A conditional indicator group may contain a determinant of health that is repeatedly contained within the plurality of photographs, such as fitness activities that a user engages in may be repeatedly contained within a plurality of photographs, and as such, a conditional indicator group may identify the repeated photographs containing fitness activities as belonging to a conditional indicator group 128 of exercise determinants of health. In yet another non-limiting example, a conditional indicator group may contain a determinant of health that is repeatedly contained within the plurality of photographs, such as pictures of meals that a user consumes as belonging to a conditional indicator group 128 of nutritional determinants of health. Computing device 104 may identify one or more conditional indicator group 128 utilizing input contained within expert database 124. Computing device 104 generates a label identifying a conditional indicator group 128. A “label,” as used in this disclosure, is data, including any numerical, symbolic, and/or character data indicating the group that a conditional indicator 120 belongs to. In an embodiment, a conditional indicator may belong to one or more groups. For instance and without limitation, a conditional indicator 120 such as meal patterns may belong to a first conditional indicator group 128 such as nutritional determinants of health and a second conditional indicator group 128 such as social determinants of health. In yet another non-limiting example, a conditional indicator 120 such as exercise habits may belong to a first conditional indicator 120 such as health behavior determinants of health, and a second conditional indicator 120 such as physical determinants of health.

With continued reference to FIG. 1, computing device 104 is configured to identify information missing from an identified conditional indicator group. Information may be missing when there is not any information pertaining to a conditional indicator group 128, and/or when there may not be enough information gathered pertaining to a conditional indicator group 128. For instance and without limitation, computing device 104 may determine that a conditional indicator group 128 containing information about a user's nutritional habits does not contain enough information because there are very few photographs contained within the plurality of photographs 108 that have information pertaining to the user's nutritional habits. Computing device 104 is configured to transmit a request to a remote device 116 operated by the human subject, to obtain more information. Computing device 104 transmits the request to a remote device 116 operated by the human subject utilizing any network methodology as described herein. A request to obtain more information may include a series of one or more questions and/or comments for a user to elaborate on. In an embodiment, a request to obtain more information may include a questionnaire, which may contain user responses to questions. In an embodiment, a request to obtain more information may be generated based on one or more expert inputs contained within expert database 124. Computing device 104 receives from the remote device 116 operated by the human subject a response containing at least an element of information. An “element of information,” as used in this disclosure, includes any information that is not possessed by computing device 104.

With continued reference to FIG. 1, computing device 104 is configured to generate a classification algorithm 132 utilizing a conditional indicator 120. A “classification algorithm,” as used in this disclosure, is a process whereby a computing device derives, from training data, a model for sorting inputs into categories or bins of data. “Training data,” as used in this disclosure, is data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning process 152 as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), enabling processes or devices to detect categories of data.

Alternatively or additionally, and still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below. Training data used by computing device 104 may correlate any input data as described in this disclosure to any output data as described in this disclosure.

With continued reference to FIG. 1, a classification algorithm may include a process whereby a computing device 104 derives, from training data, a model for sorting inputs into categories or bins of data. Training data includes any of the training data as described herein. Classification may be performed using, without limitation, linear classifiers such as without limitation logistic regression and/or naive Bayes classifiers, nearest neighbor classifiers including without limitation k-nearest neighbors classifiers, support vector machines, decision trees, boosted trees, random forest classifiers, and/or neural network-based classifiers.

With continued reference to FIG. 1, classification algorithm 132 may include generating a Naïve Bayes classification algorithm 132. Naïve Bayes classification algorithm 132 generates classifiers by assigning class labels to problem instances, represented as vectors of feature values. Class labels are drawn from a finite set. Naïve Bayes classification algorithm 132 may include generating a family of algorithms that assume that the value of a particular feature is independent of the value of any other feature, given a class variable. Naïve Bayes classification algorithm 132 may be based on Bayes Theorem expressed as P(A/B)═P(B/A) P(A)═P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming classification training data into a frequency table. Computing device 104 may then calculate a likelihood table by calculating probabilities of different data entries and classification labels. Computing device 104 utilizes a naïve Bayes equation to calculate a posterior probability for each class. A class containing the highest posterior probability is the outcome of prediction. Naïve Bayes classification algorithm 132 may include a gaussian model that follows a normal distribution. Naïve Bayes classification algorithm 132 may include a multinomial model that is used for discrete counts. Naïve Bayes classification algorithm 132 may include a Bernoulli model that may be utilized when feature vectors are binary. Naïve Bayes classification algorithm 132 utilizes training data and at least a retrieved element of user data as an input to output a user metabolic state. A metabolic state may be identified utilizing a classification label, where a “classification label” as used in this disclosure, includes a label that indicates whether an input belongs to a particular class or not. In an embodiment, a classification label may include an indication as to the metabolic state of the user. For example, a user with hyperthyroidism who is a hyper-metabolizer may be classified to a metabolic state that indicates that the user is a hypermetabolizer, whereas a user who is not active, and does not engage in physical activity may be classified to a metabolic state that indicates that the user is a slow metabolizer.

With continued reference to FIG. 1, classification algorithm 132 may include generating a K-nearest neighbor (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=Σᵢ₌₀ⁿaᵢ², where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, classification algorithm 132 utilizes a conditional indicator 120 as an input and outputs a conditional profile 136. A “conditional profile,” as used in this disclosure, is data including any numerical, character, and/or symbolic data describing the overall health and/or well-being of a human subject. A conditional profile 136 may include information describing one or more suspected conditions that a user may be suffering from. A “condition,” as used in this disclosure, is the identification of any state of a user's health. A condition may identify a likelihood or percentage chance that a user suffers from a specific illness such as a user who has a depressed mood, low energy, and fatigue may have a high likelihood of suffering from an illness of depression. A condition may identify the likelihood of a user suffering from a pre-condition, such as pre-diabetes. A condition may identify a likelihood that a user will develop a disease such as the likelihood that a user will develop heart disease or breast cancer. A condition may identify a health status that may reflect one or more indicators of health. For instance, and without limitation, a classification algorithm 132 may utilize a conditional indicator 120 such as pale names to classify the user to a conditional profile 136 that reflects the likelihood that a user has anemia. In yet another non-limiting example, a classification algorithm 132 may utilize a conditional indicator 120 such as breakouts on chin/jawline to classify the user to a conditional profile 136 that reflects the likelihood that a user has a hormone disruption.

Still referring to FIG. 1, in some embodiments, a computing device may implement one or more aspects of “generative artificial intelligence,” a type of artificial intelligence (AI) that uses machine learning algorithms to create, establish, or otherwise generate data such as, without limitation, conditional profile and/or the like in any data structure as described herein (e.g., text, image, video, audio, among others) that is similar to one or more provided training examples. For example, classification algorithm 132 may be implemented using generative artificial intelligence. In an embodiment, machine learning module described herein may generate one or more generative machine learning models that are trained on one or more sets of training data such as conditional indicators. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

Still referring to FIG. 1, in some cases, generative machine learning models may include one or more generative models. As described herein, a “generative model” refers to a statistical model of the joint probability distribution P(X, Y) on a given observable variable x, representing features or data that can be directly measured or observed and target variable y, representing the outcomes or labels that one or more generative models aims to predict or generate. For example, such variable x may include conditional indicator and such variable y may include conditional profile.

Still referring to FIG. 1, in some cases, generative models may rely on Bayes theorem to find joint probability; for instance, and without limitation, Naïve Bayes classifiers may be employed by computing device to categorize input data such as, without limitation, conditional indicator into different categories such as, without limitation, condition type.

Still referring to FIG. 1, in some embodiments, one or more generative machine learning models may include one or more Naïve Bayes classifiers generated, by computing device, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)═P(B/A) P(A)═P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing Device may then calculate a likelihood table by calculating probabilities of different data entries and classification labels. Computing device may utilize a naïve Bayes equation to calculate a posterior probability for each class. A class containing the highest posterior probability is the outcome of prediction.

Still referring to FIG. 1, although Naïve Bayes classifier may be primarily known as a probabilistic classification algorithm; however, it may also be considered a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)═P(Y)ΠiP (Xi|Y), wherein P(Y) may be the prior probability of the class, and P(Xᵢ|Y) is the conditional probability of each feature given the class. One or more generative machine learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine learning models may include one or more Naïve Bayes classifiers to generate new examples of conditional profile based on classification of conditional indicator (e.g. condition type), wherein the models may be trained using training data containing a plurality of features e.g., features of conditional indicator, and/or the like as input correlated to a plurality of labeled classes e.g., condition type as output.

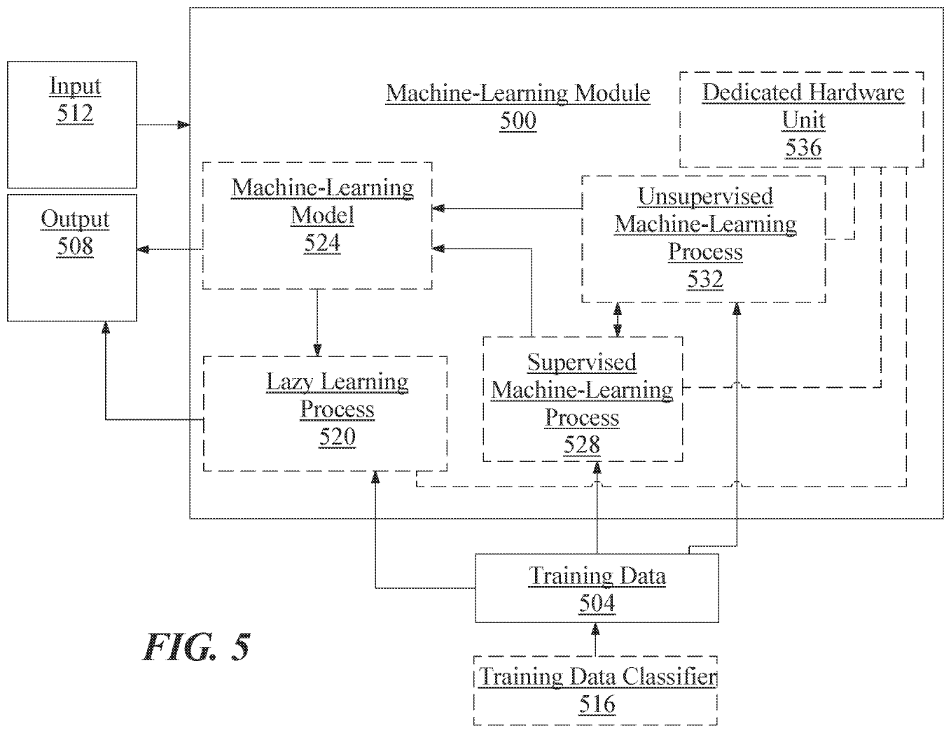

Still referring to FIG. 1, in some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 5.

Still referring to FIG. 1, in some embodiments, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 5 to distinguish between different categories such as real vs fake or correct vs incorrect, or states such as TRUE vs. FALSE within the context of generated data such as, without limitations, conditional profile, and/or the like. In some cases, computing device may implement one or more classification algorithms such as, without limitation, Support Vector Machines (SVM), Logistic Regression, Decision Trees, and/or the like to define decision boundaries.

Still referring to FIG. 1, in some embodiments, generator of GAN may be responsible for creating synthetic data that resembles real conditional profile. In some cases, GAN may be configured to receive conditional indicator as input and generates corresponding conditional profile containing information describing or evaluating the performance of one or more instances of conditional indicator. On the other hand, discriminator of GAN may evaluate the authenticity of the generated content by comparing it to real conditional profile, for example, discriminator may distinguish between genuine and generated content and providing feedback to generator to improve the model performance.

Still referring to FIG. 1, in some embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

Still referring to FIG. 1, in some embodiments, VAE may be used by computing device to model complex relationships between conditional indicator. In some cases, VAE may encode input data into a latent space, capturing conditional profile. Such encoding process may include learning one or more probabilistic mappings from observed conditional indicator to a lower-dimensional latent representation. Latent representation may then be decoded back into the original data space, therefore reconstructing the conditional indicator. In some cases, such decoding process may allow VAE to generate new examples or variations that are consistent with the learned distributions.

Still referring to FIG. 1, in some embodiments, one or more generative machine learning models may be trained on audio-visual data as described herein, wherein the audio-visual data may provide visual/acoustic information that generative machine learning models analyze to understand the dynamics of a subject. In other embodiments, training data may also include voice-over instructions, feedback, or the like. In some cases, such data may help generative machine learning models to learn appropriate language and tone for providing an audio natural language output.

Still referring to FIG. 1, in some embodiments, one or more generative machine learning models may utilize one or more predefined templates representing, for example, and without limitation, correct conditional profile. In a non-limiting example, one or more templates (i.e., predefined models or representations of correct and ideal conditional profile) may serve as benchmarks for comparing and evaluating conditional indicator.

Still referring to FIG. 1, computing device may configure generative machine learning models to analyze input data to one or more predefined templates, thereby allowing computing device to identify discrepancies or deviations from a desired form of conditional profile. In some cases, computing device may be configured to pinpoint specific errors in conditional indicator. In a non-limiting example, computing device may be configured to implement generative machine learning models to incorporate additional models to detect additional instances of conditional indicator. In some cases, errors may be classified into different categories or severity levels. In a non-limiting example, some errors may be considered minor, and generative machine learning model such as, without limitation, GAN may be configured to generate conditional profile contain only slight adjustments while others may be more significant and demand more substantial corrections. In some embodiments, computing device may be configured to flag or highlight an error in input data such as dust on a camera lens and computing device may edit conditional indicator using one or more generative machine learning models described herein. In some cases, one or more generative machine learning models may be configured to generate and output indicators such as, without limitation, visual indicator, audio indicator, and/or any other indicators as described above. Such indicators may be used to signal the detected error described herein.

Still referring to FIG. 1, in some cases, computing device may be configured to identify, and rank detected common deficiencies across a plurality of data sources; for instance, and without limitation, one or more machine learning models may classify errors in a specific order such as by ranking deficiencies in a descending order of commonality. Such ranking process may enable a prioritization of most prevalent issues, allowing instructors or computing device to address the issue.

Still referring to FIG. 1, in some cases, one or more generative machine learning models may also be applied by computing device to edit, modify, or otherwise manipulate existing data or data structures. In an embodiment, output of training data used to train one or more generative machine learning models such as GAN as described herein may include training data that linguistically or visually demonstrate modified conditional indicator. In some cases, conditional profile may be synchronized with conditional indicator. In some cases, such conditional profile may be integrated with the conditional indicator, offering a user a multisensory instructional experience.

Still referring to FIG. 1, computing device may be configured to continuously monitor conditional indicator. In an embodiment, computing device may configure discriminator to provide ongoing feedback and further corrections as needed to subsequent input data. In some cases, one or more sensors such as, without limitation, wearable device, motion sensor, or other sensors or devices described herein may provide additional conditional indicator that may be used as subsequent input data or training data for one or more generative machine learning models described herein. An iterative feedback loop may be created as computing device continuously receive real-time data, identify errors as a function of real-time data, delivering corrections based on the identified errors, and monitoring a response on the delivered corrections. In an embodiment, computing device may be configured to retrain one or more generative machine learning models based on a response or update training data of one or more generative machine learning models by integrating a response into the original training data. In such embodiment, iterative feedback loop may allow machine learning module to adapt to a user's needs, enabling one or more generative machine learning models described herein to learn and update based on a response and generated feedback.

Still referring to FIG. 1, other exemplary embodiments of generative machine learning models may include, without limitation, long short-term memory networks (LSTMs), (generative pre-trained) transformer (GPT) models, mixture density networks (MDN), and/or the like.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by computing device to generate conditional profile. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others.

With continued reference to FIG. 1, computing device 104 is configured to retrieve an element of user physiological data 140. As used in this disclosure, “physiological state data” is any data indicative of a person's physiological state. Physiological state may be evaluated with regard to one or more measures of health of a person's body, one or more systems within a person's body such as a circulatory system, a digestive system, a nervous system, or the like, one or more organs within a person's body, and/or any other subdivision of a person's body useful for diagnostic or prognostic purposes. For instance, and without limitation, a particular set of biomarkers, test results, and/or biochemical information may be recognized in a given medical field as useful for identifying various disease conditions or prognoses within a relevant field. As a non-limiting example, and without limitation, physiological data describing red blood cells, such as red blood cell count, hemoglobin levels, hematocrit, mean corpuscular volume, mean corpuscular hemoglobin, and/or mean corpuscular hemoglobin concentration may be recognized as useful for identifying various conditions such as dehydration, high testosterone, nutrient deficiencies, kidney dysfunction, chronic inflammation, anemia, and/or blood loss.

With continued reference to FIG. 1, physiological state data may include, without limitation, hematological data, such as red blood cell count, which may include a total number of red blood cells in a person's blood and/or in a blood sample, hemoglobin levels, hematocrit representing a percentage of blood in a person and/or sample that is composed of red blood cells, mean corpuscular volume, which may be an estimate of the average red blood cell size, mean corpuscular hemoglobin, which may measure average weight of hemoglobin per red blood cell, mean corpuscular hemoglobin concentration, which may measure an average concentration of hemoglobin in red blood cells, platelet count, mean platelet volume which may measure the average size of platelets, red blood cell distribution width, which measures variation in red blood cell size, absolute neutrophils, which measures the number of neutrophil white blood cells, absolute quantities of lymphocytes such as B-cells, T-cells, Natural Killer Cells, and the like, absolute numbers of monocytes including macrophage precursors, absolute numbers of eosinophils, and/or absolute counts of basophils. Physiological state data may include, without limitation, immune function data such as Interleukine-6 (IL-6), TNF-alpha, systemic inflammatory cytokines, and the like.

Continuing to refer to FIG. 1, physiological state data may include, without limitation, data describing blood-born lipids, including total cholesterol levels, high-density lipoprotein (HDL) cholesterol levels, low-density lipoprotein (LDL) cholesterol levels, very low-density lipoprotein (VLDL) cholesterol levels, levels of triglycerides, and/or any other quantity of any blood-born lipid or lipid-containing substance. Physiological state data may include measures of glucose metabolism such as fasting glucose levels and/or hemoglobin A1-C (HbA1c) levels. Physiological state data may include, without limitation, one or more measures associated with endocrine function, such as without limitation, quantities of dehydroepiandrosterone (DHEAS), DHEA-Sulfate, quantities of cortisol, ratio of DHEAS to cortisol, quantities of testosterone quantities of estrogen, quantities of growth hormone (GH), insulin-like growth factor 1 (IGF-1), quantities of adipokines such as adiponectin, leptin, and/or ghrelin, quantities of somatostatin, progesterone, or the like. Physiological state data may include measures of estimated glomerular filtration rate (eGFR). Physiological state data may include quantities of C-reactive protein, estradiol, ferritin, folate, homocysteine, prostate-specific Ag, thyroid-stimulating hormone, vitamin D, 25 hydroxy, blood urea nitrogen, creatinine, sodium, potassium, chloride, carbon dioxide, uric acid, albumin, globulin, calcium, phosphorus, alkaline phosphatase, alanine amino transferase, aspartate amino transferase, lactate dehydrogenase (LDH), bilirubin, gamma-glutamyl transferase (GGT), iron, and/or total iron binding capacity (TIBC), or the like. Physiological state data may include antinuclear antibody levels. Physiological state data may include aluminum levels. Physiological state data may include arsenic levels. Physiological state data may include levels of fibrinogen, plasma cystatin C, and/or brain natriuretic peptide.

Continuing to refer to FIG. 1, physiological state data may include measures of lung function such as forced expiratory volume, one second (FEV-1) which measures how much air can be exhaled in one second following a deep inhalation, forced vital capacity (FVC), which measures the volume of air that may be contained in the lungs. Physiological state data may include a measurement blood pressure, including without limitation systolic and diastolic blood pressure. Physiological state data may include a measure of waist circumference. Physiological state data may include body mass index (BMI). Physiological state data may include one or more measures of bone mass and/or density such as dual-energy x-ray absorptiometry. Physiological state data may include one or more measures of muscle mass. Physiological state data may include one or more measures of physical capability such as without limitation measures of grip strength, evaluations of standing balance, evaluations of gait speed, pegboard tests, timed up and go tests, and/or chair rising tests.

Still viewing FIG. 1, physiological state data may include one or more measures of cognitive function, including without limitation Rey auditory verbal learning test results, California verbal learning test results, NIH toolbox picture sequence memory test, Digital symbol coding evaluations, and/or Verbal fluency evaluations. Physiological state data may include one or more evaluations of sensory ability, including measures of audition, vision, olfaction, gustation, vestibular function and pain.

Continuing to refer to FIG. 1, physiological state data may include psychological data. Psychological data may include any data generated using psychological, neuro-psychological, and/or cognitive evaluations, as well as diagnostic screening tests, personality tests, personal compatibility tests, or the like; such data may include, without limitation, numerical score data entered by an evaluating professional and/or by a subject performing a self-test such as a computerized questionnaire. Psychological data may include textual, video, or image data describing testing, analysis, and/or conclusions entered by a medical professional such as without limitation a psychologist, psychiatrist, psychotherapist, social worker, a medical doctor, or the like. Psychological data may include data gathered from user interactions with persons, documents, and/or computing devices 104; for instance, user patterns of purchases, including electronic purchases, communication such as via chatrooms or the like, any textual, image, video, and/or data produced by the subject, any textual image, video and/or other data depicting and/or describing the subject, or the like. Any psychological data and/or data used to generate psychological data may be analyzed using machine-learning and/or language processing module as described in this disclosure. As a non-limiting example, biological extraction may include a psychological profile; the psychological profile may be obtained utilizing a questionnaire performed by the user.

Still referring to FIG. 1, physiological state data may include genomic data, including deoxyribonucleic acid (DNA) samples and/or sequences, such as without limitation DNA sequences or other genetic sequences contained in one or more chromosomes in human cells. Genomic data may include, without limitation, ribonucleic acid (RNA) samples and/or sequences, such as samples and/or sequences of messenger RNA (mRNA) or the like taken from human cells. Genetic data may include telomere lengths. Genomic data may include epigenetic data including data describing one or more states of methylation of genetic material. Physiological state data may include proteomic data, which as used herein is data describing all proteins produced and/or modified by an organism, colony of organisms, or system of organisms, and/or a subset thereof. Physiological state data may include data concerning a microbiome of a person, which as used herein includes any data describing any microorganism and/or combination of microorganisms living on or within a person, including without limitation biomarkers, genomic data, proteomic data, and/or any other metabolic or biochemical data useful for analysis of the effect of such microorganisms on other physiological state data of a person, as described in further detail below.

With continuing reference to FIG. 1, physiological state data may include one or more user-entered descriptions of a person's physiological state. One or more user-entered descriptions may include, without limitation, user descriptions of symptoms, which may include without limitation current or past physical, psychological, perceptual, and/or neurological symptoms, user descriptions of current or past physical, emotional, and/or psychological problems and/or concerns, user descriptions of past or current treatments, including therapies, nutritional regimens, exercise regimens, pharmaceuticals or the like, or any other user-entered data that a user may provide to a medical professional when seeking treatment and/or evaluation, and/or in response to medical intake papers, questionnaires, questions from medical professionals, or the like. Physiological state data may include any physiological state data, as described above, describing any multicellular organism living in or on a person including any parasitic and/or symbiotic organisms living in or on the persons; non-limiting examples may include mites, nematodes, flatworms, or the like. Examples of physiological state data described in this disclosure are presented for illustrative purposes only and are not meant to be exhaustive.

With continued reference to FIG. 1, physiological data may include, without limitation, any result of any medical test, physiological assessment, cognitive assessment, psychological assessment, or the like. System 100 may receive at least a physiological data from one or more other devices after performance; system 100 may alternatively or additionally perform one or more assessments and/or tests to obtain at least a physiological data, and/or one or more portions thereof, on system 100. For instance, at least physiological data may include one or more entries by a user in a form or similar graphical user interface object; one or more entries may include, without limitation, user responses to questions on a psychological, behavioral, personality, or cognitive test. For instance, at least a server may present to user a set of assessment questions designed or intended to evaluate a current state of mind of the user, a current psychological state of the user, a personality trait of the user, or the like; at least a server may provide user-entered responses to such questions directly as at least a physiological data and/or may perform one or more calculations or other algorithms to derive a score or other result of an assessment as specified by one or more testing protocols, such as automated calculation of a Stanford-Binet and/or Wechsler scale for IQ testing, a personality test scoring such as a Myers-Briggs test protocol, or other assessments that may occur to persons skilled in the art upon reviewing the entirety of this disclosure.

With continued reference to FIG. 1, assessment and/or self-assessment data, and/or automated or other assessment results, obtained from a third-party device 116; third-party device 116 may include, without limitation, a server or other device (not shown) that performs automated cognitive, psychological, behavioral, personality, or other assessments. Third-party device 116 may include a device operated by an informed advisor. An informed advisor may include any medical professional who may assist and/or participate in the medical treatment of a user. An informed advisor may include a medical doctor, nurse, physician assistant, pharmacist, yoga instructor, nutritionist, spiritual healer, meditation teacher, fitness coach, health coach, life coach, and the like.

With continued reference to FIG. 1, physiological data may include data describing one or more test results, including results of mobility tests, stress tests, dexterity tests, endocrinal tests, genetic tests, and/or electromyographic tests, biopsies, radiological tests, genetic tests, and/or sensory tests. Persons skilled in the art, upon reviewing the entirety of this disclosure, will be aware of various additional examples of at least a physiological sample consistent with this disclosure.

With continued reference to FIG. 1, physiological data may include one or more user body measurements. A “user body measurement” as used in this disclosure, includes a measurable indicator of the severity, absence, and/or presence of a disease state. A “disease state” as used in this disclosure, includes any harmful deviation from the normal structural and/or function state of a human being. A disease state may include any medical condition and may be associated with specific symptoms and signs. A disease state may be classified into different types including infectious diseases, deficiency diseases, hereditary diseases, and/or physiological diseases. For instance and without limitation, internal dysfunction of the immune system may produce a variety of different diseases including immunodeficiency, hypersensitivity, allergies, and/or autoimmune disorders.

With continued reference to FIG. 1, user body measurements may be related to particular dimensions of the human body. A “dimension of the human body” as used in this disclosure, includes one or more functional body systems that are impaired by disease in a human body and/or animal body. Functional body systems may include one or more body systems recognized as attributing to root causes of disease by functional medicine practitioners and experts. A “root cause” as used in this disclosure, includes any chain of causation describing underlying reasons for a particular disease state and/or medical condition instead of focusing solely on symptomatology reversal. Root cause may include chains of causation developed by functional medicine practices that may focus on disease causation and reversal. For instance and without limitation, a medical condition such as diabetes may include a chain of causation that does not include solely impaired sugar metabolism but that also includes impaired hormone systems including insulin resistance, high cortisol, less than optimal thyroid production, and low sex hormones. Diabetes may include further chains of causation that include inflammation, poor diet, delayed food allergies, leaky gut, oxidative stress, damage to cell membranes, and dysbiosis. Dimensions of the human body may include but are not limited to epigenetics, gut-wall, microbiome, nutrients, genetics, and/or metabolism.

With continued reference to FIG. 1, epigenetic, as used herein, includes any user body measurements describing changes to a genome that do not involve corresponding changes in nucleotide sequence. Epigenetic body measurement may include data describing any heritable phenotypic. Phenotype, as used herein, include any observable trait of a user including morphology, physical form, and structure. Phenotype may include a user's biochemical and physiological properties, behavior, and products of behavior. Behavioral phenotypes may include cognitive, personality, and behavior patterns. This may include effects on cellular and physiological phenotypic traits that may occur due to external or environmental factors. For example, DNA methylation and histone modification may alter phenotypic expression of genes without altering underlying DNA sequence. Epigenetic body measurements may include data describing one or more states of methylation of genetic material.

With continued reference to FIG. 1, gut-wall, as used herein, includes the space surrounding the lumen of the gastrointestinal tract that is composed of four layers including the mucosa, submucosa, muscular layer, and serosa. The mucosa contains the gut epithelium that is composed of goblet cells that function to secrete mucus, which aids in lubricating the passage of food throughout the digestive tract. The goblet cells also aid in protecting the intestinal wall from destruction by digestive enzymes. The mucosa includes villi or folds of the mucosa located in the small intestine that increase the surface area of the intestine. The villi contain a lacteal, which is a vessel connected to the lymph system that aids in removal of lipids and tissue fluids. Villi may contain microvilli that increase the surface area over which absorption can take place. The large intestine lack villi and instead a flat surface containing goblet cells are present.

With continued reference to FIG. 1, gut-wall includes the submucosa, which contains nerves, blood vessels, and elastic fibers containing collagen. Elastic fibers contained within the submucosa aid in stretching the gastrointestinal tract with increased capacity while also maintaining the shape of the intestine. Gut-wall includes muscular layer which contains smooth muscle that aids in peristalsis and the movement of digested material out of and along the gut. Gut-wall includes the serosa which is composed of connective tissue and coated in mucus to prevent friction damage from the intestine rubbing against other tissue. Mesenteries are also found in the serosa and suspend the intestine in the abdominal cavity to stop it from being disturbed when a person is physically active.

With continued reference to FIG. 1, gut-wall body measurement may include data describing one or more test results including results of gut-wall function, gut-wall integrity, gut-wall strength, gut-wall absorption, gut-wall permeability, intestinal absorption, gut-wall barrier function, gut-wall absorption of bacteria, gut-wall malabsorption, gut-wall gastrointestinal imbalances and the like.

With continued reference to FIG. 1, gut-wall body measurement may include any data describing blood test results of creatinine levels, lactulose levels, zonulin levels, and mannitol levels. Gut-wall body measurement may include blood test results of specific gut-wall body measurements including d-lactate and endotoxin lipopolysaccharide (LPS). Gut-wall body measurement may include data breath tests measuring lactulose, hydrogen, methane, lactose, and the like. Gut-wall body measurement may include blood test results describing blood chemistry levels of albumin, bilirubin, complete blood count, electrolytes, minerals, sodium, potassium, calcium, glucose, and blood clotting factors.

With continued reference to FIG. 1, gut-wall body measurement may include one or more stool test results describing presence or absence of parasites, firmicutes, Bacteroidetes, absorption, inflammation, food sensitivities. Stool test results may describe presence, absence, and/or measurement of acetate, aerobic bacterial cultures, anerobic bacterial cultures, fecal short chain fatty acids, beta-glucuronidase, cholesterol, chymotrypsin, fecal color, cryptosporidium EIA, Entamoeba histolytica, fecal lactoferrin, Giardia lamblia EIA, long chain fatty acids, meat fibers and vegetable fibers, mucus, occult blood, parasite identification, phospholipids, propionate, putrefactive short chain fatty acids, total fecal fat, triglycerides, yeast culture, n-butyrate, pH and the like.

With continued reference to FIG. 1, gut-wall body measurement may include one or more stool test results describing presence, absence, and/or measurement of microorganisms including bacteria, archaea, fungi, protozoa, algae, viruses, parasites, worms, and the like. Stool test results may contain species such as Bifidobacterium species, campylobacter species, Clostridium difficile, cryptosporidium species, Cyclospora cayetanensis, Cryptosporidium EIA, Dientamoeba fragilis, Entamoeba histolytica, Escherichia coli, Entamoeba histolytica, Giardia, H. pylori, Candida albicans, Lactobacillus species, worms, macroscopic worms, mycology, protozoa, Shiga toxin E. coli, and the like.

With continued reference to FIG. 1, gut-wall body measurement may include one or more microscopic ova exam results, microscopic parasite exam results, protozoan polymerase chain reaction test results and the like. Gut-wall body measurement may include enzyme-linked immunosorbent assay (ELISA) test results describing immunoglobulin G (Ig G) food antibody results, immunoglobulin E (Ig E) food antibody results, Ig E mold results, IgG spice and herb results. Gut-wall body measurement may include measurements of calprotectin, eosinophil protein x (EPX), stool weight, pancreatic elastase, total urine volume, blood creatinine levels, blood lactulose levels, blood mannitol levels.

With continued reference to FIG. 1, gut-wall body measurement may include one or more elements of data describing one or more procedures examining gut including for example colonoscopy, endoscopy, large and small molecule challenge and subsequent urinary recovery using large molecules such as lactulose, polyethylene glycol-3350, and small molecules such as mannitol, L-rhamnose, polyethyleneglycol-400. Gut-wall body measurement may include data describing one or more images such as x-ray, MRI, CT scan, ultrasound, standard barium follow-through examination, barium enema, barium with contract, MRI fluoroscopy, positron emission tomography 9PET), diffusion-weighted MRI imaging, and the like.

With continued reference to FIG. 1, microbiome, as used herein, includes ecological community of commensal, symbiotic, and pathogenic microorganisms that reside on or within any of a number of human tissues and biofluids. For example, human tissues and biofluids may include the skin, mammary glands, placenta, seminal fluid, uterus, vagina, ovarian follicles, lung, saliva, oral mucosa, conjunctiva, biliary, and gastrointestinal tracts. Microbiome may include for example, bacteria, archaea, protists, fungi, and viruses. Microbiome may include commensal organisms that exist within a human being without causing harm or disease. Microbiome may include organisms that are not harmful but rather harm the human when they produce toxic metabolites such as trimethylamine. Microbiome may include pathogenic organisms that cause host damage through virulence factors such as producing toxic by-products. Microbiome may include populations of microbes such as bacteria and yeasts that may inhabit the skin and mucosal surfaces in various parts of the body. Bacteria may include for example Firmicutes species, Bacteroidetes species, Proteobacteria species, Verrumicrobia species, Actinobacteria species, Fusobacteria species, Cyanobacteria species and the like. Archaea may include methanogens such as Methanobrevibacter smithies' and Methanosphaera stadtmanae. Fungi may include Candida species and Malassezia species. Viruses may include bacteriophages. Microbiome species may vary in different locations throughout the body. For example, the genitourinary system may contain a high prevalence of Lactobacillus species while the gastrointestinal tract may contain a high prevalence of Bifidobacterium species while the lung may contain a high prevalence of Streptococcus and Staphylococcus species.

With continued reference to FIG. 1, microbiome body measurement may include one or more stool test results describing presence, absence, and/or measurement of microorganisms including bacteria, archaea, fungi, protozoa, algae, viruses, parasites, worms, and the like. Stool test results may contain species such as Ackerman's muciniphila, Anaerotruncus colihominis, bacteriology, Bacteroides vulgates', Bacteroides-Prevotella, Barnesiella species, Bifidobacterium longarm, Bifidobacterium species, Butyrivibrio crossotus, Clostridium species, Collinsella aerofaciens, fecal color, fecal consistency, Coprococcus eutactus, Desulfovibrio piger, Escherichia coli, Faccalibacterium prausnitzii, Fecal occult blood, Firmicutes to Bacteroidetes ratio, Fusobacterium species, Lactobacillus species, Methanobrevibacter smithii, yeast minimum inhibitory concentration, bacteria minimum inhibitory concentration, yeast mycology, fungi mycology, Odoribacter species, Oxalobacter formigenes, parasitology, Prevotella species, Pseudoflavonifractor species, Roseburia species, Ruminococcus species, Veillonella species and the like.

With continued reference to FIG. 1, microbiome body measurement may include one or more stool tests results that identify all microorganisms living a user's gut including bacteria, viruses, archaea, yeast, fungi, parasites, and bacteriophages. Microbiome body measurement may include DNA and RNA sequences from live microorganisms that may impact a user's health. Microbiome body measurement may include high resolution of both species and strains of all microorganisms. Microbiome body measurement may include data describing current microbe activity. Microbiome body measurement may include expression of levels of active microbial gene functions. Microbiome body measurement may include descriptions of sources of disease-causing microorganisms, such as viruses found in the gastrointestinal tract such as raspberry bushy swarf virus from consuming contaminated raspberries or Pepino mosaic virus from consuming contaminated tomatoes.

With continued reference to FIG. 1, microbiome body measurement may include one or more blood test results that identify metabolites produced by microorganisms. Metabolites may include for example, indole-3-propionic acid, indole-3-lactic acid, indole-3-acetic acid, tryptophan, serotonin, kynurenine, total indoxyl sulfate, tyrosine, xanthine, 3-methylxanthine, uric acid, and the like.

With continued reference to FIG. 1, microbiome body measurement may include one or more breath test results that identify certain strains of microorganisms that may be present in certain areas of a user's body. This may include for example, lactose intolerance breath tests, methane-based breath tests, hydrogen-based breath tests, fructose-based breath tests, Helicobacter pylori breath test, fructose intolerance breath test, bacterial overgrowth syndrome breath tests and the like.

With continued reference to FIG. 1, microbiome body measurement may include one or more urinary analysis results for certain microbial strains present in urine. This may include for example, urinalysis that examines urine specific gravity, urine cytology, urine sodium, urine culture, urinary calcium, urinary hematuria, urinary glucose levels, urinary acidity, urinary protein, urinary nitrites, bilirubin, red blood cell urinalysis, and the like.

With continued reference to FIG. 1, nutrient as used herein, includes any substance required by the human body to function. Nutrients may include carbohydrates, protein, lipids, vitamins, minerals, antioxidants, fatty acids, amino acids, and the like. Nutrients may include for example vitamins such as thiamine, riboflavin, niacin, pantothenic acid, pyridoxine, biotin, folate, cobalamin, Vitamin C, Vitamin A, Vitamin D, Vitamin E, and Vitamin K. Nutrients may include for example minerals such as sodium, chloride, potassium, calcium, phosphorous, magnesium, sulfur, iron, zinc, iodine, selenium, copper, manganese, fluoride, chromium, molybdenum, nickel, aluminum, silicon, vanadium, arsenic, and boron.

With continued reference to FIG. 1, nutrients may include extracellular nutrients that are free floating in blood and exist outside of cells. Extracellular nutrients may be located in serum. Nutrients may include intracellular nutrients which may be absorbed by cells including white blood cells and red blood cells.

With continued reference to FIG. 1, nutrient body measurement may include one or more blood test results that identify extracellular and intracellular levels of nutrients. Nutrient body measurement may include blood test results that identify serum, white blood cell, and red blood cell levels of nutrients. For example, nutrient body measurement may include serum, white blood cell, and red blood cell levels of micronutrients such as Vitamin A, Vitamin B1, Vitamin B2, Vitamin B3, Vitamin B6, Vitamin B12, Vitamin B5, Vitamin C, Vitamin D, Vitamin E, Vitamin K1, Vitamin K2, and folate.

With continued reference to FIG. 1, nutrient body measurement may include one or more blood test results that identify serum, white blood cell and red blood cell levels of nutrients such as calcium, manganese, zinc, copper, chromium, iron, magnesium, copper to zinc ratio, choline, inositol, carnitine, methylmalonic acid (MMA), sodium, potassium, asparagine, glutamine, serine, coenzyme q10, cysteine, alpha lipoic acid, glutathione, selenium, eicosapentaenoic acid (EPA), docosahexaenoic acid (DHA), docosapentaenoic acid (DPA), total omega-3, lauric acid, arachidonic acid, oleic acid, total omega 6, and omega 3 index.

With continued reference to FIG. 1, nutrient body measurement may include one or more salivary test results that identify levels of nutrients including any of the nutrients as described herein. Nutrient body measurement may include hair analysis of levels of nutrients including any of the nutrients as described herein.

With continued reference to FIG. 1, genetic as used herein, includes any inherited trait. Inherited traits may include genetic material contained with DNA including for example, nucleotides. Nucleotides include adenine (A), cytosine (C), guanine (G), and thymine (T). Genetic information may be contained within the specific sequence of an individual's nucleotides and sequence throughout a gene or DNA chain. Genetics may include how a particular genetic sequence may contribute to a tendency to develop a certain disease such as cancer or Alzheimer's disease.

With continued reference to FIG. 1, genetic body measurement may include one or more results from one or more blood tests, hair tests, skin tests, urine, amniotic fluid, buccal swabs and/or tissue test to identify a user's particular sequence of nucleotides, genes, chromosomes, and/or proteins. Genetic body measurement may include tests that example genetic changes that may lead to genetic disorders. Genetic body measurement may detect genetic changes such as deletion of genetic material or pieces of chromosomes that may cause Duchenne Muscular Dystrophy. Genetic body measurement may detect genetic changes such as insertion of genetic material into DNA or a gene such as the BRCA1 gene that is associated with an increased risk of breast and ovarian cancer due to insertion of 2 extra nucleotides. Genetic body measurement may include a genetic change such as a genetic substitution from a piece of genetic material that replaces another as seen with sickle cell anemia where one nucleotide is substituted for another. Genetic body measurement may detect a genetic change such as a duplication when extra genetic material is duplicated one or more times within a person's genome such as with Charcot-Marie Tooth disease type 1. Genetic body measurement may include a genetic change such as an amplification when there is more than a normal number of copies of a gene in a cell such as HER2 amplification in cancer cells. Genetic body measurement may include a genetic change such as a chromosomal translocation when pieces of chromosomes break off and reattach to another chromosome such as with the BCR-ABL1 gene sequence that is formed when pieces of chromosome 9 and chromosome 22 break off and switch places. Genetic body measurement may include a genetic change such as an inversion when one chromosome experiences two breaks and the middle piece is flipped or inverted before reattaching. Genetic body measurement may include a repeat such as when regions of DNA contain a sequence of nucleotides that repeat a number of times such as for example in Huntington's disease or Fragile X syndrome. Genetic body measurement may include a genetic change such as a trisomy when there are three chromosomes instead of the usual pair as seen with Down syndrome with a trisomy of chromosome 21, Edwards syndrome with a trisomy at chromosome 18 or Patau syndrome with a trisomy at chromosome 13. Genetic body measurement may include a genetic change such as monosomy such as when there is an absence of a chromosome instead of a pair, such as in Turner syndrome.

With continued reference to FIG. 1, genetic body measurement may include an analysis of COMT gene that is responsible for producing enzymes that metabolize neurotransmitters. Genetic body measurement may include an analysis of DRD2 gene that produces dopamine receptors in the brain. Genetic body measurement may include an analysis of ADRA2B gene that produces receptors for noradrenaline. Genetic body measurement may include an analysis of 5-HTTLPR gene that produces receptors for serotonin. Genetic body measurement may include an analysis of BDNF gene that produces brain derived neurotrophic factor. Genetic body measurement may include an analysis of 9p21 gene that is associated with cardiovascular disease risk. Genetic body measurement may include an analysis of APOE gene that is involved in the transportation of blood lipids such as cholesterol. Genetic body measurement may include an analysis of NOS3 gene that is involved in producing enzymes involved in regulating vasodilation and vasoconstriction of blood vessels.

With continued reference to FIG. 1, genetic body measurement may include ACE gene that is involved in producing enzymes that regulate blood pressure. Genetic body measurement may include SLCO1B1 gene that directs pharmaceutical compounds such as statins into cells. Genetic body measurement may include FUT2 gene that produces enzymes that aid in absorption of Vitamin B12 from digestive tract. Genetic body measurement may include MTHFR gene that is responsible for producing enzymes that aid in metabolism and utilization of Vitamin B9 or folate. Genetic body measurement may include SHMT1 gene that aids in production and utilization of Vitamin B9 or folate. Genetic body measurement may include MTRR gene that produces enzymes that aid in metabolism and utilization of Vitamin B12. Genetic body measurement may include MTR gene that produces enzymes that aid in metabolism and utilization of Vitamin B12. Genetic body measurement may include FTO gene that aids in feelings of satiety or fullness after eating. Genetic body measurement may include MC4R gene that aids in producing hunger cues and hunger triggers. Genetic body measurement may include APOA2 gene that directs body to produce ApoA2 thereby affecting absorption of saturated fats. Genetic body measurement may include UCP1 gene that aids in controlling metabolic rate and thermoregulation of body. Genetic body measurement may include TCF7L2 gene that regulates insulin secretion. Genetic body measurement may include AMY gene that aids in digestion of starchy foods. Genetic body measurement may include MCM6 gene that controls production of lactase enzyme that aids in digesting lactose found in dairy products. Genetic body measurement may include BCMO1 gene that aids in producing enzymes that aid in metabolism and activation of Vitamin A. Genetic body measurement may include SLC23A1 gene that produce and transport Vitamin C. Genetic body measurement may include CYP2R1 gene that produce enzymes involved in production and activation of Vitamin D. Genetic body measurement may include GC gene that produce and transport Vitamin D. Genetic body measurement may include CYP1A2 gene that aid in metabolism and elimination of caffeine. Genetic body measurement may include CYP17A1 gene that produce enzymes that convert progesterone into androgens such as androstenedione, androstenediol, dehydroepiandrosterone, and testosterone.

With continued reference to FIG. 1, genetic body measurement may include CYP19A1 gene that produce enzymes that convert androgens such as androstenedione and testosterone into estrogens including estradiol and estrone. Genetic body measurement may include SRD5A2 gene that aids in production of enzymes that convert testosterone into dihydrotestosterone. Genetic body measurement may include UFT2B17 gene that produces enzymes that metabolize testosterone and dihydrotestosterone. Genetic body measurement may include CYP1A1 gene that produces enzymes that metabolize estrogens into 2 hydroxy-estrogen. Genetic body measurement may include CYP1B1 gene that produces enzymes that metabolize estrogens into 4 hydroxy-estrogen. Genetic body measurement may include CYP3A4 gene that produces enzymes that metabolize estrogen into 16 hydroxy-estrogen. Genetic body measurement may include COMT gene that produces enzymes that metabolize 2 hydroxy-estrogen and 4 hydroxy-estrogen into methoxy estrogen. Genetic body measurement may include GSTT1 gene that produces enzymes that eliminate toxic by-products generated from metabolism of estrogens. Genetic body measurement may include GSTM1 gene that produces enzymes responsible for eliminating harmful by-products generated from metabolism of estrogens. Genetic body measurement may include GSTP1 gene that produces enzymes that eliminate harmful by-products generated from metabolism of estrogens. Genetic body measurement may include SOD2 gene that produces enzymes that eliminate oxidant by-products generated from metabolism of estrogens.

With continued reference to FIG. 1, metabolic, as used herein, includes any process that converts food and nutrition into energy. Metabolic may include biochemical processes that occur within the body. Metabolic body measurement may include blood tests, hair tests, skin tests, amniotic fluid, buccal swabs and/or tissue test to identify a user's metabolism. Metabolic body measurement may include blood tests that examine glucose levels, electrolytes, fluid balance, kidney function, and liver function. Metabolic body measurement may include blood tests that examine calcium levels, albumin, total protein, chloride levels, sodium levels, potassium levels, carbon dioxide levels, bicarbonate levels, blood urea nitrogen, creatinine, alkaline phosphatase, alanine amino transferase, aspartate amino transferase, bilirubin, and the like.

With continued reference to FIG. 1, metabolic body measurement may include one or more blood, saliva, hair, urine, skin, and/or buccal swabs that examine levels of hormones within the body such as 11-hydroxy-androsterone, 11-hydroxy-etiocholanolone, 11-keto-androsterone, 11-keto-etiocholanolone, 16 alpha-hydroxyestrone, 2-hydroxyestrone, 4-hydroxyestrone, 4-methoxyestrone, androstanediol, androsterone, creatinine, DHEA, estradiol, estriol, estrone, etiocholanolone, pregnanediol, pregnanetriol, specific gravity, testosterone, tetrahydrocortisol, tetrahydrocortisone, tetrahydrodeoxycortisol, and allo-tetrahydrocortisol.

With continued reference to FIG. 1, metabolic body measurement may include one or more metabolic rate test results such as breath tests that may analyze a user's resting metabolic rate or number of calories that a user's body burns each day at rest. Metabolic body measurement may include one or more vital signs including blood pressure, breathing rate, pulse rate, temperature, and the like. Metabolic body measurement may include blood tests such as a lipid panel such as low density lipoprotein (LDL), high density lipoprotein (HDL), triglycerides, total cholesterol, ratios of lipid levels such as total cholesterol to HDL ratio, insulin sensitivity test, fasting glucose test, Hemoglobin A1C test, adipokines such as leptin and adiponectin, neuropeptides such as ghrelin, pro-inflammatory cytokines such as interleukin 6 or tumor necrosis factor alpha, anti-inflammatory cytokines such as interleukin 10, markers of antioxidant status such as oxidized low-density lipoprotein, uric acid, and paraoxonase 1. Persons skilled in the art, upon reviewing the entirety of this disclosure, will be aware of various additional examples of physiological state data that may be used consistently with descriptions of systems and methods as provided in this disclosure.

With continued reference to FIG. 1, physiological data may be obtained from a physically extracted sample. A “physical sample” as used in this example, may include any sample obtained from a human body of a user. A physical sample may be obtained from a bodily fluid and/or tissue analysis such as a blood sample, tissue, sample, buccal swab, mucous sample, stool sample, hair sample, fingernail sample and the like. A physical sample may be obtained from a device in contact with a human body of a user such as a microchip embedded in a user's skin, a sensor in contact with a user's skin, a sensor located on a user's tooth, and the like. Physiological data may be obtained from a physically extracted sample. A physical sample may include a signal from a sensor configured to detect physiological data of a user and record physiological data as a function of the signal. A sensor may include any medical sensor and/or medical device configured to capture sensor data concerning a patient, including any scanning, radiological and/or imaging device such as without limitation x-ray equipment, computer assisted tomography (CAT) scan equipment, positron emission tomography (PET) scan equipment, any form of magnetic resonance imagery (MRI) equipment, ultrasound equipment, optical scanning equipment such as photo-plethysmographic equipment, or the like. A sensor may include any electromagnetic sensor, including without limitation electroencephalographic sensors, magnetoencephalographic sensors, electrocardiogram sensors, electromyographic sensors, or the like. A sensor may include a temperature sensor. A sensor may include any sensor that may be included in a mobile device and/or wearable device, including without limitation a motion sensor such as an inertial measurement unit (IMU), one or more accelerometers, one or more gyroscopes, one or more magnetometers, or the like. At least a wearable and/or mobile device sensor may capture step, gait, and/or other mobility data, as well as data describing activity levels and/or physical fitness. At least a wearable and/or mobile device sensor may detect heart rate or the like. A sensor may detect any hematological parameter including blood oxygen level, pulse rate, heart rate, pulse rhythm, blood sugar, and/or blood pressure. A sensor may be configured to detect internal and/or external biomarkers and/or readings. A sensor may be a part of system 100 or may be a separate device in communication with system 100. User data may include a profile, such as a psychological profile, generated using previous item selections by the user; profile may include, without limitation, a set of actions and/or navigational actions performed as described in further detail below, which may be combined with biological extraction data and/or other user data for processes such as classification to user sets as described in further detail below.

Still referring to FIG. 1, retrieval of biological extraction may include, without limitation, reception of biological extraction from another computing device 104 such as a device operated by a medical and/or diagnostic professional and/or entity, a user client device, and/or any device suitable for use as a third-party device as described in further detail below. Biological extraction may be received via a questionnaire posted and/or displayed on a third-party device as described below, inputs to which may be processed as described in further detail below. Alternatively or additionally, biological extraction may be stored in and/or retrieved from a user database 144. User database 144 may include any data structure for ordered storage and retrieval of data, which may be implemented as a hardware or software module. A user database 144 may be implemented, without limitation, as a relational database, a key-value retrieval datastore such as a NOSQL database, or any other format or structure for use as a datastore that a person skilled in the art would recognize as suitable upon review of the entirety of this disclosure. A user database 144 may include a plurality of data entries and/or records corresponding to user tests as described above. Data entries in a user database 144 may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a user database 144 may reflect categories, cohorts, and/or populations of data consistently with this disclosure. User database 144 may be located in memory of computing device 104 and/or on another device in and/or in communication with system 100.

With continued reference to FIG. 1, and as noted above, retrieval of biological extract may be performed multiple sequential and/or concurrent times, and any process using biological extract as described below may be performed multiple sequential and/or concurrent times; likewise, biological extract may include multiple elements of physiological data, which may be used in combination for any determination and/or other processes as described below.

An element of physiological data may include a user reported element of physiological data. A user reported element of physiological data may include any medical data pertaining to a user, supplied by a user. For example, a user reported element of physiological data may include any previous health history, health records, diagnosis, medications, treatments, major surgeries, complications, and the like that the user may be suffering from. For example, a user reported an element of physiological data may include an anaphylactic reaction to all tree nuts that the user was diagnosed with as a young child. In yet another non-limiting example, a user reported element of physiological data may describe a previous diagnosis such as endometriosis that the user was diagnosed with three years back, and treatments that the user engages in to manage her endometriosis, including supplementation with fish oil and following a gluten free diet. In yet another non-limiting example, a user may provide one or more elements of health history information, such as when a user may select how much of a user's medical records the user seeks to share with computing device 104. For example, a user may prefer to share only the user's hospitalization records and not the user's current medication list. In yet another non-limiting example, a user may seek to share as many records as are available for the user, such as the user's entire vaccination history. In yet another non-limiting example, a user may share health history information that is available to the user, such as when records may become lost or misplaced. An element of physiological data may include an amount of information or certain records based on a user's entire medical record that the user seeks to share and allow system 100 and/or a computing device 104 to have access to. For example, a user may prefer to share only the user's hospitalization records and not the user's current medication list. In yet another non-limiting example, a user may seek to share as many records as are available for the user, such as the user's entire health history. In yet another non-limiting example, a user may not wish to share any information pertaining to a user's health history. In yet another non-limiting example, a user may be unable to share any information pertaining to a user's health history, because the user may be adopted and may not have access to health records, or the user is unable to locate any health records for the user and the like. An element of physiological data may include a user reported self-assessment. A “self-assessment” as used in this disclosure, is any questionnaire that may prompt and/or ask a user for any element of user health history. For instance and without limitation, a self-assessment may seek to obtain information including demographic information such as a user's full legal name, sex, date of birth, marital status, date of last physical exam and the like. A self-assessment may seek to obtain information regarding a user's childhood illness such as if the user suffered from measles, mumps, rubella, chickenpox, rheumatic fever, polio and the like. A self-assessment may seek to obtain any vaccination information and dates a user received vaccinations such as tetanus, hepatitis, influenza, pneumonia, chickenpox, measles mumps and rubella (MMR), and the like. A self-assessment may seek to obtain any medical problems that other doctors and/or medical professionals may have diagnosed. A self-assessment may seek to obtain any information about surgeries or hospitalizations the user experienced. A self-assessment may seek to obtain information about previously prescribed drugs, over-the-counter drugs, supplements, vitamins, and/or inhalers the user was prescribed. A self-assessment may seek to obtain information regarding a user's health habits such as exercise preferences, nutrition and diet that a user follows, caffeine consumption, alcohol consumption, tobacco use, recreational drug use, sexual health, personal safety, family health history, mental health, other problems, other remarks, information pertaining to women only, information pertaining to men only and the like. Computing device 104 is configured to generate the classification algorithm 132 utilizing the element of user physiological data 140.

With continued reference to FIG. 1, computing device 104 is configured to determine a conditional status 148 of a human subject utilizing a conditional profile 136. A “conditional status” as used in this disclosure, is an identification of a health condition that a user may be suffering from. A conditional status 148 may identify a disease likelihood score, defined for the purposes of this disclosure as a quantitative datum that indicates the likelihood that a user has a disease. A likelihood may include a numerical likelihood reported on a scale, and/or may include a likelihood reported based on character values indicating how probable or likely it is that a user has a disease. For instance and without limitation, a conditional status 148 may indicate that a user who has pale lips, a swollen face, and red eyes may have a high likelihood of suffering from a disease such as a common cold. In yet another non-limiting example, a conditional status 148 may indicate that a user who has a very small social network consisting of a few friends, consumes alcohol, and does not exercise has a moderate likelihood of having depression. A conditional status 148 includes a treatment identifier. A “treatment identifier,” as used in this disclosure, is an element of data identifying a therapeutic agent and/or remedy, which may correct or lessen a condition identified within a conditional status 148. A treatment identifier may include treatments that include prescription medications, over the counter medications, vitamins, supplements, herbals, nutritional interventions, fitness programs, meditation sequences, yoga classes and the like. For instance and without limitation, computing device 104 may generate for a user with a condition such as the common cold, a treatment identifier that includes chicken and rice soup, along with elderberry supplement and plenty of fluids. In yet another non-limiting example, a treatment identifier may recommend excess consumption of cruciferous vegetables for a user with a condition such as pre-menstrual syndrome (PMS).

With continued reference to FIG. 1, computing device 104 determines the conditional status 148 of a human subject utilizing a machine-learning process 152. A machine learning process may include a process that automatedly uses a body of data known as training data and/or a training set to generate an algorithm that will be performed by a computing device 104 and/or module to produce outputs given data provided as inputs; this is in contrast to a non-machine learning software program where the commands to be executed are determined in advance by a user and written in a programming language.

With continued reference to FIG. 1, computing device 104 may be designed and configured to create a machine-learning model using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 1, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Still referring to FIG. 1, models may be generated using alternative or additional artificial intelligence methods, including without limitation by creating an artificial neural network, such as a convolutional neural network comprising an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. This network may be trained using training data.

Continuing to refer to FIG. 1, machine-learning algorithms may include supervised machine-learning algorithms. Supervised machine learning algorithms, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may utilize a conditional profile 136 as described above as inputs, a conditional status 148 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data. Persons skilled in the art, upon reviewing the entirety of this disclosure, will be aware of various possible variations of supervised machine learning algorithms that may be used to determine relation between inputs and outputs. Supervised machine-learning processes 152 may include classification algorithm 132 as defined above.

Still referring to FIG. 1, machine learning processes may include unsupervised processes. An unsupervised machine-learning process 152, as used herein, is a process that derives inferences in datasets without regard to labels; as a result, an unsupervised machine-learning process 152 may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

With continued reference to FIG. 1, machine-learning process 152 as described in this disclosure may be used to generate machine-learning models. A machine-learning model may include a mathematical representation of a relationship between inputs and outputs, as generated using any machine-learning process including without limitation any process as described above, and stored in memory; an input is submitted to a machine-learning model once created, which generates an output based on the relationship that was derived. For instance, and without limitation, a linear regression model, generated using a linear regression algorithm, may compute a linear combination of input data using coefficients derived during machine-learning processes 152 to calculate an output datum. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 1, at least a machine-learning process 152 may include a lazy-learning process and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data. Heuristic may include selecting some number of highest-ranking associations and/or training data elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below. Computing device 104 calculates a machine-learning process 152 wherein the machine-learning process 152 utilizes a conditional profile 136 as an input and outputs a conditional status. Computing device 104 determines the conditional status 148 of a human subject utilizing the machine-learning process.

With continued reference to FIG. 1, computing device 104 is configured to transmit the conditional status 148 of a human subject to a remote device 116 operated by an informed advisor. An “informed advisor,” as used in this disclosure, includes any individual who may be involved in contributing to the health and well-being of the human subject. An informed advisor may include a physician, doctor, nurse, physician assistant, nurse practitioner, pharmacist, psychiatrist, psychologist, nutritionist, dietician, yoga instructor, meditation teacher, spiritual advisor, church leader, and the like. Computing device 104 receives an input generated by an informed advisor in response to the conditional status 148 of the human subject. In an embodiment, an input generated by an informed advisor may provide background information, confirm information about a user, update information about a user, and/or provide feedback regarding a conditional status. For example, an input generated by a user's nutritional advisor may confirm a disease likelihood contained within a conditional status 148 and indicate that a user does have a Vitamin D deficiency. In yet another non-limiting example, an input generated by an informed advisor may confirm that a treatment identifier contained within a conditional status 148 is appropriate for a user. Computing device 104 updates a conditional status 148 utilizing an input generated by an informed advisor. Updating a conditional status 148 may include updating a disease likelihood score so as to confirm the likelihood of a user disease.

Still referring to FIG. 1, in some embodiments, apparatus 100 may determine a conditional profile adjustment datum as a function of a conditional profile 136. As used herein, a “conditional profile adjustment datum” is a datum identifying a therapy which may be applied to a human subject in order to change a feature of a conditional profile associated with the human subject. As used herein, a “feature” of a conditional profile is a measurable aspect of a human subject associated with the health of the human subject. A therapy which may be identified may include, in non-limiting examples, a prescription medication, a supplement, an over the counter drug, and a lifestyle change. In some embodiments, apparatus 100 may determine conditional profile adjustment datum by identifying one or more drugs, lifestyle changes, and the like recommended by medical professionals as a therapy for a condition identified in conditional profile 136 and/or conditional status. In some embodiments, apparatus 100 may determine conditional profile adjustment datum by identifying one or more drugs approved to treat a condition identified in conditional profile 136 and/or conditional status. In some embodiments, apparatus 100 may determine conditional profile adjustment datum by retrieving from a database a list of one or more recommended therapies for condition identified in conditional profile 136 and/or conditional status.

Still referring to FIG. 1, in some embodiments, apparatus 100 may communicate conditional profile adjustment datum to a human subject. In some embodiments, apparatus 100 may communicate conditional profile adjustment datum to a human subject using a user interface. A user interface may include an input interface and/or an output interface. An input interface may include, in non-limiting examples, a button, keyboard, mouse, trackpad, microphone, touchscreen, controller, joystick, camera, and the like. An output interface may include, in non-limiting examples, a screen, speaker, haptic feedback system, and the like. In some embodiments, apparatus 100 may communicate conditional profile adjustment datum to a human subject by transmitting conditional profile adjustment datum to a remote device, such that the remote device is configured to communicate conditional profile adjustment datum to the human subject. A remote device may include, in non-limiting examples, a desktop computer, a laptop computer, a tablet, a smartphone, and a smartwatch. In some embodiments, apparatus 100 may generate a visual element as a function of conditional profile adjustment datum and may display the visual element to a human subject. Visual elements are described further below.

Still referring to FIG. 1, in some embodiments, apparatus 100 may communicate a feedback prompt to a human subject. As used herein, a “feedback prompt” is a datum displayed to a human subject which is likely to elicit feedback from the human subject. In some embodiments, apparatus 100 may receive feedback from a human subject. As used herein, “feedback” is a datum or other input originating from a human subject which describes a feature of a therapy applied to the human subject, a feature of the human subject after receiving a therapy, or both. In a non-limiting example, apparatus 100 may transmit a datum to a smartphone operated by a human subject, and the datum may configure the smartphone to display to the human subject a request that the human subject describe how the human subject has been feeling since a recent therapy. Feedback may be received in a variety of formats, such as a selection of a status of human subject from a list of options, a freeform text response, a verbal audio response, a photo of the human subject, a video of the human subject, and the like. Feedback may include, in non-limiting examples, a review of a therapy by a human subject which has received the therapy, a description by a human subject of actions the human subject can and/or cannot perform due to a therapy, a description by a human subject of how a therapy has affected those around the human subject, and the like. In some embodiments, feedback may be used to determine conditional profile adjustment datum. For example, apparatus 100 may determine a first conditional profile adjustment datum, a human subject may receive a therapy based on the first conditional profile adjustment datum, the human subject may provide feedback to apparatus 100 based on the therapy, and apparatus 100 may determine a second conditional profile adjustment datum as a function of the first conditional profile adjustment datum and/or the feedback.

Still referring to FIG. 1, in some embodiments, apparatus 100 may receive more than one set of photographs related to a human subject. Apparatus 100 may receive a first set of photographs and a second set of photographs of plurality of photographs. Apparatus 100 may identify a conditional indicator as a function of each set of photographs. Apparatus 100 may generate a conditional profile 136 as a function of each conditional indicator. In some embodiments, a first set of photographs of plurality of photographs is associated with a first point in time and/or a first time frame, and second set of photographs of plurality of photographs is associated with a second point in time and/or a second time frame. Apparatus 100 may determine a profile velocity datum as a function of two conditional profiles, such as two conditional profiles associated with photograph sets taken at different times. As used herein, a “profile velocity datum” is a datum describing a change, a rate of change, or both from a first conditional profile to a second conditional profile, where both conditional profiles are associated with the same human subject. In some embodiments, such a change may describe a change in health of a human subject associated with the conditional profiles. In a non-limiting example, a profile velocity datum may describe a change in weight of a human subject. In some embodiments, apparatus 100 may determine a profile velocity datum by retrieving data associated with conditional profiles of a human subject at two distinct points in time and finding a change and/or rate of change in the data. In a non-limiting example, finding a change in subject weight may be performed by subtracting an initial subject weight from a final subject weight.

Still referring to FIG. 1, in some embodiments, apparatus 100 may communicate to a human subject a medical professional identifier. As used herein, a “medical professional identifier” is a datum enabling a human subject to identify, contact, or both a medical professional, an entity associated with a medical professional, an account associated with a medical professional, or a combination thereof. In non-limiting examples, a medical professional identifier may include an email address, a physical address, a name, a phone number, and/or a social media account associated with a medical professional. Similarly, a medical professional identifier may include an email address, a physical address, a name, a phone number, and/or a social media account associated with a hospital or other organization a medical professional is associated with.

Still referring to FIG. 1, a conditional indicator may be identified as a function of metadata associated with a photograph of a plurality of photographs. Such metadata may include, in non-limiting examples, information as to when a photograph was taken, a caption of a photograph, and one or more objects or individuals tagged in a photograph.

Still referring to FIG. 1, in some embodiments, apparatus 100 may prompt a human subject to capture a photograph, input a photograph, or both. In some embodiments, prompts may be used to capture data when insufficient data would otherwise be available. For example, an insufficient number of photographs may be received for apparatus 100 to perform a process herein with a high degree of accuracy. In another example, many photographs may be captured at a first point in time, but few may be captured at other points in time. In another example, photographs received may be of poor quality, low resolution, and/or relevant information may be obscured. In such cases, apparatus 100 may prompt a human subject to input additional photographs. In some embodiments, prompts to capture images may be given periodically. Receipt of images captured periodically may provide more information than, for example, several images captured within a short time frame. For example, capturing images periodically may provide more detailed information about lifestyle of a user than images which would otherwise be received, which in some cases may not be representative of lifestyle of a user.

Still referring to FIG. 1, in some embodiments, a conditional profile adjustment datum may identify a therapy associated with a conditional status. Conditional status is described in greater detail above. A therapy associated with a conditional status may include, for example, a therapy approved to treat a disease or other condition associated with conditional status. Identification of a therapy may include, in non-limiting examples, a trade name of a drug, and a scientific name of a drug. In some embodiments, apparatus 100 may communicate to a human subject identity information of an entity providing a therapy. Such identity information may include, in non-limiting examples, an email address, a physical address, a name, a phone number, and a social media account associated with an entity. In some embodiments, apparatus 100 may display to a human subject a visual element as a function of a therapy associated with conditional status.

Still referring to FIG. 1, in some embodiments, a visual element data structure may include a visual element. As used herein, a “visual element” is a datum that is displayed visually to a user. In some embodiments, a visual element data structure may include a rule for displaying visual element. In some embodiments, a visual element data structure may be determined as a function of a therapy associated with conditional status. In some embodiments, a visual element data structure may be determined as a function of an item from the list consisting of a photograph, a plurality of photographs, a conditional indicator, a classifier, a conditional profile, a conditional status, a therapy associated with a conditional status, and an entity providing such a therapy. In a non-limiting example, a visual element data structure may be generated such that visual element describing or highlighting a therapy associated with conditional status is displayed to a human subject.

Still referring to FIG. 1, in some embodiments, visual element may include one or more elements of text, images, shapes, charts, particle effects, interactable features, and the like.

Still referring to FIG. 1, a visual element data structure may include rules governing if or when visual element is displayed. In a non-limiting example, a visual element data structure may include a rule causing a visual element describing a therapy associated with conditional status to be displayed when a user selects a therapy associated with conditional status using a graphical user interface (GUI).

Still referring to FIG. 1, a visual element data structure may include rules for presenting more than one visual element, or more than one visual element at a time. In an embodiment, about 1, 2, 3, 4, 5, 10, 20, or 50 visual elements are displayed simultaneously.

Still referring to FIG. 1, a visual element data structure rule may apply to a single visual element or datum, or to more than one visual element or datum. A visual element data structure may categorize data into one or more categories and may apply a rule to all data in a category, to all data in an intersection of categories, or all data in a subsection of a category (such as all data in a first category and not in a second category). A visual element data structure may rank data or assign numerical values to them. A numerical value may, for example, measure the degree to which a first datum is associated with a category or with a second datum. A visual element data structure may apply rules based on a comparison between a ranking or numerical value and a threshold. Rankings, numerical values, categories, and the like may be used to set visual element data structure rules. Similarly, rankings, numerical values, categories, and the like may be applied to visual elements, and visual elements may be applied based on them.

Still referring to FIG. 1, in some embodiments, visual element may be interacted with. For example, visual element may include an interface, such as a button or menu. In some embodiments, visual element may be interacted with using a user device such as a smartphone.

Still referring to FIG. 1, in some embodiments, apparatus 100 may transmit visual element data structure to a remote device. In some embodiments, apparatus 100 may include at least a processor 104 and a memory 108 communicatively connected to the at least processor 104, the memory 108 containing instructions 112 configuring the at least processor 104 to transmit visual element data structure to a remote device. In some embodiments, visual element data structure may configure a remote device to display visual element. In some embodiments, visual element data structure may cause an event handler to be triggered in an application of a remote device such as a web browser. In some embodiments, triggering of an event handler may cause a change in an application of a remote device such as display of visual element.

Still referring to FIG. 1, in some embodiments, apparatus 100 may transmit visual element to a display. A display may communicate visual element to human subject. A display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, that allow human subject to input data into the display. Interactive elements may be configured to enable interaction between a user and a computing device. In some embodiments, a visual element data structure is determined as a function of data input by human subject into a display.

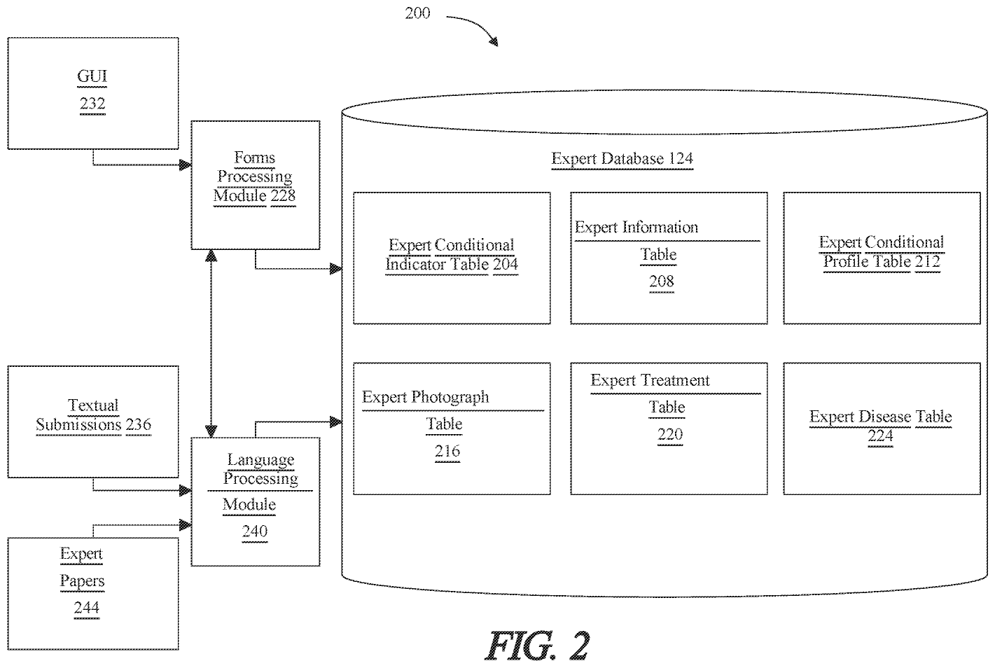

Referring now to FIG. 2, an exemplary embodiment 200 of expert database 124 is illustrated. Expert database 124 may, as a non-limiting example, organize data stored in the expert database 124 according to one or more database tables. One or more database tables may be linked to one another by, for instance, common column values. For instance, a common column between two tables of expert database 124 may include an identifier of an expert submission, such as a form entry, textual submission, expert paper, or the like, for instance as defined below; as a result, a query may be able to retrieve all rows from any table pertaining to a given submission or set thereof. Other columns may include any other category usable for organization or subdivision of expert data, including types of expert data, names and/or identifiers of experts submitting the data, times of submission, or the like; persons skilled in the art, upon reviewing the entirety of this disclosure, will be aware of various ways in which expert data from one or more tables may be linked and/or related to expert data in one or more other tables.

Still referring to FIG. 2, one or more database tables in expert database 124 may include, as a non-limiting example, an expert conditional indicator table 204; expert conditional indicator 204 may include expert information relating to conditional indicator 120. One or more database tables in expert database 124 may include, as a non-limiting example, an expert information table 208; expert information table 208 may include expert information relating to any information necessary within system 100, including for example, information relating to conditional indicators. One or more database tables in expert database 124 may include expert conditional profile 212; expert conditional profile table 212 may include expert information relating to conditional profile 136. One or more database tables in expert database 124 may include expert photograph table 216; expert photograph table 216 may include expert information relating to photographs. One or more database tables in expert database 124 may include expert treatment table 220; expert treatment table 220 may include expert information relating to treatments. One or more database tables in expert database 124 may include expert disease table 224; expert disease table 224 may include expert information relating to diseases.

In an embodiment, and still referring to FIG. 2, a forms processing module 228 may sort data entered in a submission via a graphical user interface 232 receiving expert submissions by, for instance, sorting data from entries in the graphical user interface 232 to related categories of data; for instance, data entered in an entry relating in the graphical user interface 232 to a conditional indicator 120 such as social determinants of health, which may be provided to expert conditional indicator 120 table 204, while data entered in an entry relating to recommended treatments for acne vulgaris, which may be provided to expert disease table 224. Where data is chosen by an expert from pre-selected entries such as drop-down lists, data may be stored directly; where data is entered in textual form, a language processing module may be used to map data to an appropriate existing label, for instance using a vector similarity test or other synonym-sensitive language processing test to map data to existing labels and/or categories. Similarly, data from an expert textual submission 236, such as accomplished by filling out a paper or PDF form and/or submitting narrative information, may likewise be processed using language processing module.

Still referring to FIG. 2, a language processing module 240 may include any hardware and/or software module. Language processing module 240 may be configured to extract, from the one or more documents, one or more words. One or more words may include, without limitation, strings of one or characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 2 language processing module 240 may compare extracted words to categories of data to be analyzed; such data for comparison may be entered on computing device 104 as described above using expert data inputs or the like. In an embodiment, one or more categories may be enumerated, to find total count of mentions in such documents. Alternatively or additionally, language processing module 240 may operate to produce a language processing model. Language processing model may include a program automatically generated by at least a server and/or language processing module 240 to produce associations between one or more words extracted from at least a document and detect associations, including without limitation mathematical associations, between such words, and/or associations between such words and other elements of data analyzed, processed and/or stored by system 100. Associations between language elements, may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of physiological data, a given relationship of such categories to prognostic labels, and/or a given category of prognostic labels. As a further example, statistical correlations and/or mathematical associations may include probabilistic formulas or relationships indicating a positive and/or negative association between at least an extracted word and/or a given category of data; positive or negative indication may include an indication that a given document is or is not indicating a category of data.

Still referring to FIG. 2, language processing module 240 and/or computing device 104 may generate the language processing model by any suitable method, including without limitation a natural language processing classification algorithm 132; language processing model may include a natural language process classification model that enumerates and/or derives statistical relationships between input term and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word category of physiological data, a given relationship of such categories to prognostic labels, and/or a given category of prognostic labels. There may be a finite number of category of physiological data, a given relationship of such categories to prognostic labels, and/or a given category of prognostic labels to which an extracted word may pertain; an HMM inference algorithm, such as the forward-backward algorithm or the Viterbi algorithm, may be used to estimate the most likely discrete state given a word or sequence of words. Language processing module 240 may combine two or more approaches. For instance, and without limitation, machine-learning program may use a combination of Naive-Bayes (NB), Stochastic Gradient Descent (SGD), and parameter grid-searching classification techniques; the result may include a classification algorithm 132 that returns ranked associations.

Continuing to refer to FIG. 2, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 2, language processing module 240 may use a corpus of documents to generate associations between language elements in a language processing module 240, and computing device 104 may then use such associations to analyze words extracted from one or more documents. Documents may be entered into computing device 104 by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, computing device 104 may automatically obtain the document using such an identifier, for instance by submitting a request to a database or compendium of documents such as JSTOR as provided by Ithaka Harbors, Inc. of New York.

With continued reference to FIG. 2, data may be extracted from expert papers 244, which may include without limitation publications in medical and/or scientific journals, by language processing module 240 via any suitable process as described herein. Persons skilled in the art, upon reviewing the entirety of this disclosure, will be aware of various additional methods whereby novel terms may be separated from already-classified terms and/or synonyms therefore, as consistent with this disclosure.

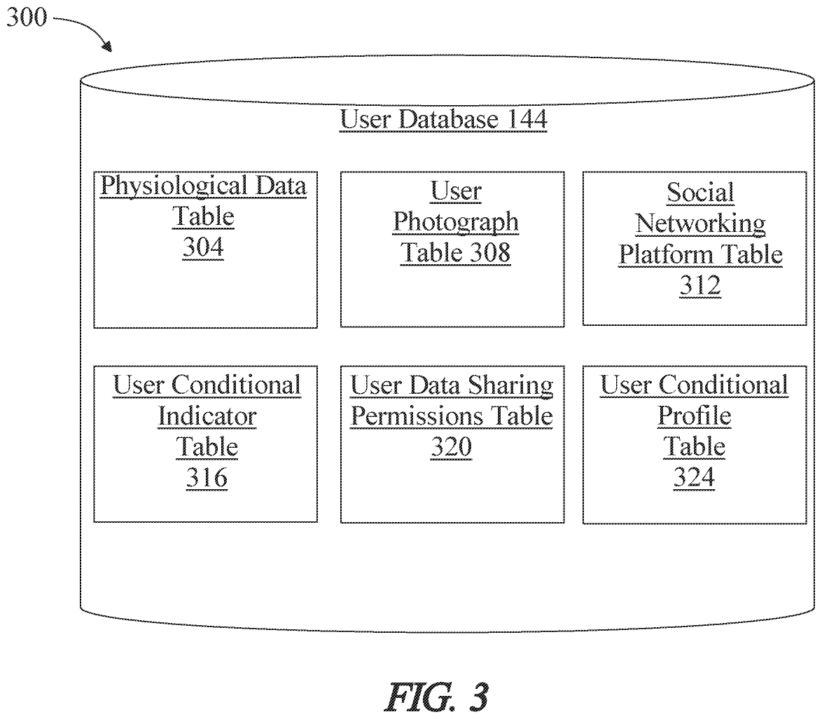

Referring now to FIG. 3, an exemplary embodiment 300 of user database 144 is illustrated. User database 144 may be implemented as any data structure suitable for use as expert database 124 as described above in more detail. One or more tables contained within user database 144 may include user physiological data table 304; user physiological data table 304 may include one or more elements of physiological data, one or more biological extractions, and/or one or more elements of user health information. One or more tables contained within user database 144 may include user photograph table 308; user photograph table 308 may include one or more photographs of a user. One or more tables contained within user database 144 may include social networking platform table 312; social networking platform table 312 may include information pertaining to one or more social networking platforms that a user may engage with. One or more tables contained within user database 144 may include conditional indicator table 316; conditional indicator table 316 may include information pertaining to one or more conditional indicator 120 for a user. One or more tables contained within user database 144 may include user data sharing permissions table 320; user data sharing permissions table 320 may include information pertaining to data a user may share with system 100 and/or with social networking platforms. One or more tables contained within user database 144 may include user conditional profile table 324; user conditional profile table 324 may include information pertaining to conditional profiles 136 relating to a user.

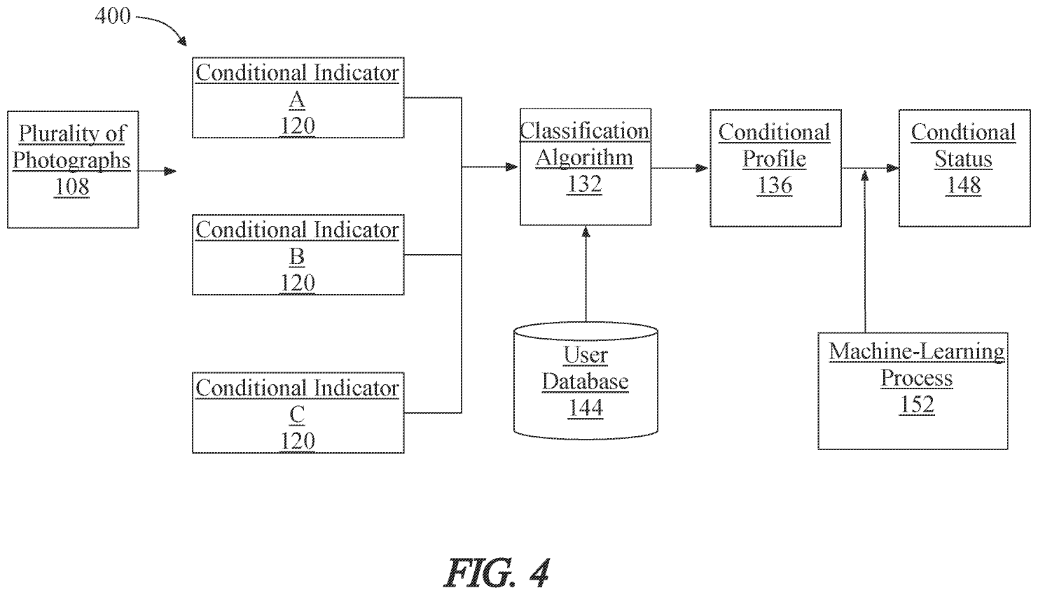

Referring now to FIG. 4, an exemplary embodiment 400 of generating a conditional status 148 is generated. Computing device 104 receives a plurality of photographs 108, which may be received from a plurality of sources. For example, photographs may be received from user inputs from remote device 116. Photographs may be received at an image capture device 112 located on computing device 104. Photographs may be received from one or more social networking platforms as described above in more detail. Computing device 104 analyzes a plurality of photographs 108 to identify one or more conditional indicator 120 describes any determinant of a user's health. In an embodiment, computing device 104 may generate a plurality of conditional indicator 120. For instance and without limitation, computing device 104 may examine a plurality of photographs 108 pertaining to a human subject and generate a first conditional indicator 120 “A” that indicates a user drinks alcohol, a second conditional indicator “B” that indicates the user engages in physical activity, and a third conditional indicator 120 “C” that indicates a the user orders takeout meals from restaurants as opposed to cooking meals at home. In an embodiment, one or more conditional indicator 120 may be generated based on input contained within expert database 124. Computing device 104 utilizes conditional indicator 120 in combination with a classification algorithm 132 to generate a conditional profile 136. Classification algorithm 132 includes any of the classification algorithm 132 as described above in more detail. Conditional profile includes any of the conditional profile 136 as described above in more detail in reference to FIG. 1. Computing device 104 utilizes a conditional profile 136 to determine a conditional status 148 of the user. A conditional status 148 may indicate the likelihood that a user has a particular disease. For example, a conditional status 148 may indicate that a user has a low likelihood of having necrotizing fasciitis, but a high likelihood of having urticaria. A conditional status 148 may contain a treatment identifier, which may identify one or more treatments available for a disease identified within a disease likelihood score. In an embodiment, a conditional status 148 may be generated based on information contained within expert database 124. In an embodiment, a conditional status 148 may be generated utilizing one or more machine-learning processes 152. A machine-learning process 152 includes any of the machine-learning processes 152 as described above in more detail in reference to FIG. 1.

Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm instantiated in hardware or software logic, data structures, and/or functions that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example, inputs may include conditional indicator and outputs may include conditional profile.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to particular health conditions and/or particular demographics.

With further reference to FIG. 5, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 5, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 5, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 5, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 5, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include conditional indicator as described above as inputs, conditional profile as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

With further reference to FIG. 5, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 5, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 532 may not require a response variable; unsupervised processes 532 may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 5, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 5, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 5, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 5, one or more processes or algorithms described above may be performed by at least a dedicated hardware unit 536. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 536 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 536 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 536 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 5, apparatus 100 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 5, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user feedback for users belonging to a particular cohort of persons may be averaged together to determine the cohort accuracy score for that particular cohort of persons and used as described above. Accuracy score or another score as described above may indicate a degree of retraining needed for a machine-learning model such as a classifier; apparatus 100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

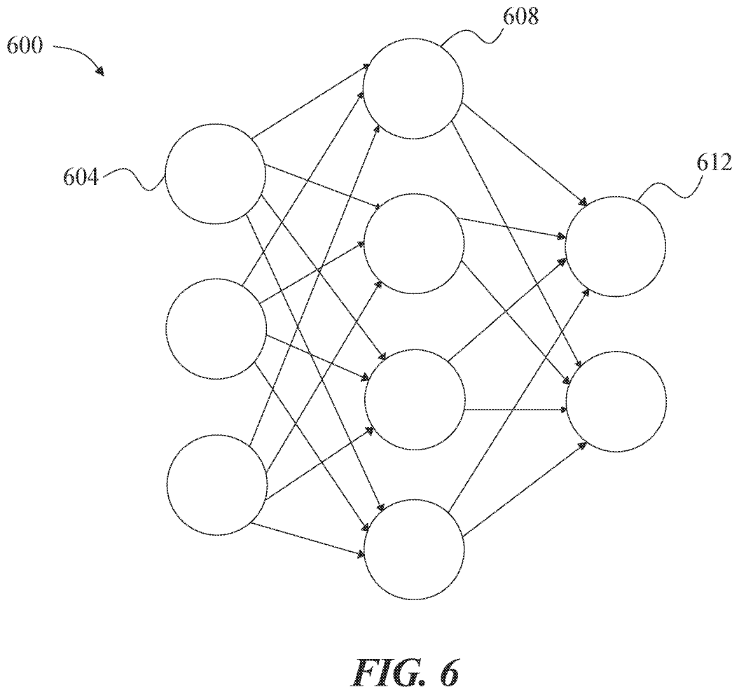

Referring now to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 604, one or more intermediate layers 608, and an output layer of nodes 612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

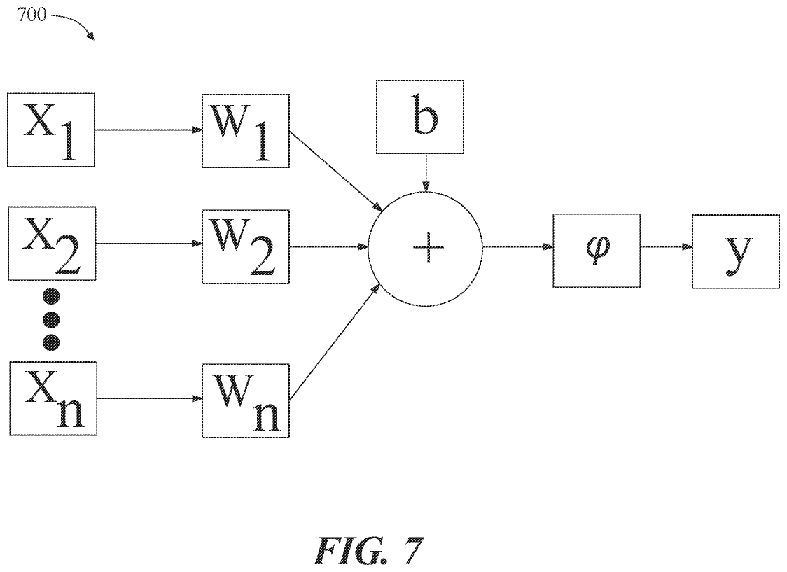

Referring now to FIG. 7, an exemplary embodiment of a node 700 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form f(x)=1/1−e^{-x} given input x, a tan h (hyperbolic tangent) function, of the form

$$\frac{{e}^{x} - {e}^{- x}}{{e}^{x} + {e}^{- x}} ,$$

a tan h derivative function such as f(x)=tan h² (x), a rectified linear unit function such as f(x)=max(0, x), a “leaky” and/or “parametric” rectified linear unit function such as f(x)=max(ax, x) for some a, an exponential linear units function such as

$$f ( x ) = λ \{ \begin{matrix}α ( {e}^{x} - 1 ) for x < 0 \\ x for x \geq 0\end{matrix} .$$

for some value of a (this function may be replaced and/or weighted by its own derivative in some embodiments), a softmax function such as

$$f ( x ) = \{ \begin{matrix}x for x \geq 0 \\ α ( {e}^{x} - 1 ) for x < 0\end{matrix}$$

where the inputs to an instant layer are xᵢ, a swish function such as f(x)=x*sigmoid(x), a Gaussian error linear unit function such as f(x)=a(1+tan h(\sqrt{2/π}(x+bx^{r}))) for some values of a, b, and r, and/or a sealed exponential linear unit function such as

$$f ( {x}_{i} ) = \frac{{e}^{x}}{{Σ}_{i} {x}_{i}}$$

Fundamentally, there is no limit to the nature of functions of inputs x; that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 7, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

Still referring to FIG. 7, in some embodiments, a convolutional neural network may learn from images. In non-limiting examples, a convolutional neural network may perform tasks such as classifying images, detecting objects depicted in an image, segmenting an image, and/or processing an image. In some embodiments, a convolutional neural network may operate such that each node in an input layer is only connected to a region of nodes in a hidden layer. In some embodiments, the regions in aggregate may create a feature map from an input layer to the hidden layer. In some embodiments, a convolutional neural network may include a layer in which the weights and biases for all nodes are the same. In some embodiments, this may allow a convolutional neural network to detect a feature, such as an edge, across different locations in an image.

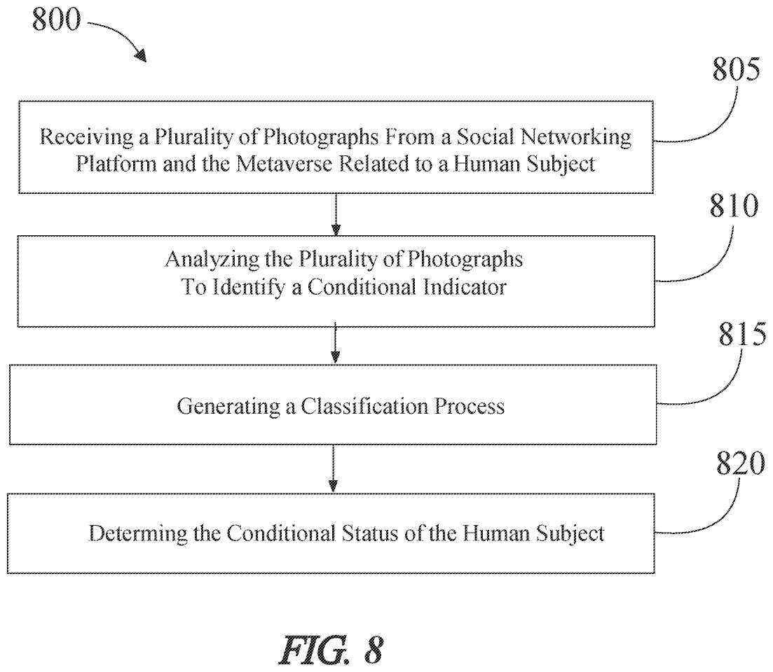

Referring now to FIG. 8, an exemplary embodiment 800 of an artificial intelligence method of analyzing imagery is illustrated. At step 805, a computing device 104 receives a plurality of photographs 108 related to a human subject. A photograph includes any of the photographs as described above in more detail in reference to FIG. 1. Computing device 104 receives at an image capture device 112 located on computing device 104 a wireless transmission from a remote device 116 containing a plurality of photographs 108 related to the human subject. An image capture device 112 includes any of the image capture device 112 as described above in more detail in reference to FIG. 1. Computing device 104 receives a wireless transmission from a remote device 116 utilizing any network methodology as described herein. In an embodiment, an image capture device 112 may be located on a remote device 116. In such an instance, a user may capture one or more photographs of the user and/or photographs related to the user as described above. A user may transmit the plurality of photographs 108 to computing device 104 utilizing any network methodology as described herein. Computing device 104 receives a plurality of photographs 108 related to a human subject from a social networking platform. A social networking platform includes any of the social networking platforms as described above in more detail in reference to FIG. 1. In an embodiment, a user may specify requirements relating to a social networking platform, indicating what social networking platforms computing device 104 may receive photographs from, dates of photographs and what dates photographs may be received from. One or more user preferences regarding social networking platforms may be stored in user database 144 as described above in more detail in reference to FIGS. 1-4. In an embodiment, computing device 104 may receive a plurality of photographs 108 from a social networking platform and/or from a website by scraping data utilizing a web scraper, as described above in more detail in reference to FIG. 1.

With continued reference to FIG. 8, at step 810, a computing device 104 analyzes a plurality of photographs 108 to identify a conditional indicator 120 contained within the plurality of photographs 108. A conditional indicator 120 includes any of the conditional indicator 120 as described above in more detail in reference to FIGS. 1-4. A conditional indicator 120 describes any determinant of health of a user, including any factor that can have an impact on one's health and wellness. A determinant of health may include factors such as where a user lives, the state of a user's home environment, genetics, income, education level, social relationships with family, friends, acquaintances and the like, race, gender, age, nutrition, social status community involvement and/or engagement, major life events, physical activity levels, smoking status, alcohol and drug use, access to healthcare, health behaviors, and the like. Computing device 104 identifies conditional indicator 120 contained within a plurality of photographs utilizing input contained within expert database 124. For instance and without limitation, computing device 104 may identify conditional indicators contained within a plurality of photographs 108 that indicate the user has a large social network of friends, the user does not drink alcohol or smoke, and the user has a butterfly shaped rash across the bridge of the user's nose and checks.

With continued reference to FIG. 8, computing device 104 identifies a conditional indicator group 128 identified within a plurality of photographs 108. A conditional indicator group 128 includes any of the conditional indicator group 128 as described above in more detail in reference to FIG. 1. A conditional indicator group may contain one or more shared determinants of health. For example, a conditional indicator group may include socioeconomic determinants of health, behavioral determinants of health, environmental determinants of health, physiological determinants of health, genetic determinants of health, epigenetic determinants of health and the like. Computing device 104 identifies a conditional indicator group 128 utilizing input contained within expert database 124. Computing device 104 generates a label identifying a conditional indicator group 128. A label includes any of the labels as described above in more detail in reference to FIG. 1. Computing device 104 identifies information missing from an identified group of a conditional indicator 120. For instance and without limitation, a conditional indicator group 128 such as behavioral determinants of health may only contain information that identifies the user as a smoker. However, information such as other behavioral determinants of health may be missing, including information regarding alcohol use, exercise frequency, supplement use, meditation practices, yoga practices and the like. Computing device 104 transmits a request to a remote device 116 operated by the human subject to obtain more information. Such a request may be transmitted utilizing any network methodology as described herein. Computing device 104 receives from the remote device 116 operated by the human subject a response containing at least an element of information. Such information received from the remote device 116 operated by the human subject may be utilized to generate classification algorithm. In an embodiment, such information received from the remote device 116 may be stored within user database 144.

With continued reference to FIG. 8, at step 815 a computing device 104 generates a classification algorithm 132 utilizing a conditional indicator 120. A classification algorithm 132 includes any of the classification algorithm 132 as described above in more detail in reference to FIG. 1. In an embodiment, computing device 104 may select a classification algorithm 132 utilizing input contained within expert database 124. A classification algorithm 132 utilizes a conditional indicator 120 as an input and outputs a conditional profile 136. A conditional profile 136 includes any of the conditional profile 136 as described above in more detail in reference to FIG. 1. A conditional profile 136 describes the overall health and/or well-being of a human subject. For example, a conditional profile 136 may describe on a sliding scale, the overall health and/or well-being of a human subject. For example, a conditional profile 136 may specify that a user is in good physical health but needs to work on emotional health because the user has very few friends and does not engage in many hobbies. In yet another non-limiting example, a conditional profile 136 may describe that a user is in poor physical health as noted from conditional indicators contained within a plurality of photographs 108 as the user appears to have puffy eyes, bloated cheeks, a pale demeanor, and looks to be exhausted. Computing device 104 is configured to retrieve an element of user physiological data 140 that may provide information utilized to generate a conditional profile 136. An element of user physiological data 140 includes any of the elements of user physiological data 140 as described above in more detail. For instance and without limitation, an element of user physiological data 140 may include a stool sample analyzed for one or more strains of bacteria inside a user's gut. In yet another non-limiting example, an element of user physiological data 140 may include a urine sample analyzed for one or more nutrients such as iodine. Computing device 104 generates a classification algorithm 132 utilizing an element of user physiological data 140. An element of user physiological data 140 may be stored in user database 144, as described above in more detail in reference to FIG. 1.

With continued reference to FIG. 8, at step 820, computing device 104 determines a conditional status 148 of a human subject utilizing the conditional profile 136. A conditional status 148, includes any of the conditional statuses 148 as described above in more detail in reference to FIG. 1. A conditional status 148 identifies any health conditions that a user may be and/or is likely to be suffering from. A health condition includes any of the health conditions as described above in more detail in reference to FIG. 1. Computing device 104 determines a conditional status 148 utilizing information contained within a conditional profile 136, indicating the overall health and/or well-being of a user. For instance and without limitation, a conditional profile 136 may indicate that a user has a very small social network, the user has very few hobbies, the user sleeps a lot, and the user has low Vitamin D. In such an instance, computing device 104 may utilize the information contained within the user's conditional profile 136 to determine a conditional status that indicates the user may be suffering from depression. A conditional status 148 may be determined utilizing input contained within expert database 124. Computing device 104 generates a conditional status 148 that contains a disease likelihood score. A disease likelihood score includes any of the disease likelihood scores as described above in more detail in reference to FIG. 1. Computing device 104 generates a conditional status 148 that contains a treatment identifier. A treatment identifier includes any of the treatment identifies as described above in more detail in reference to FIG. 1. Computing device 104 determines a conditional status by calculating a machine-learning process 152. A machine-learning process 152 includes any of the machine-learning processes as described above in more detail in reference to FIG. 1. A machine-learning process 152 utilizes a conditional profile 136 as an input and outputs a conditional status 148. Computing device 104 determines the conditional status 148 of a human subject utilizing a machine-learning process 152.

With continued reference to FIG. 8, computing device 104 transmits a conditional status 148 of a human subject to a remote device 116 operated by an informed advisor. An informed advisor includes any of the informed advisors as described above in more detail in reference to FIG. 1. A conditional status 148 may be transmitted from computing device 104 to a remote device 116 operated by an informed advisor utilizing any network methodology as described herein. Computing device 104 receives an input generated by the informed advisor in response to the conditional status 148 of the human subject. In an embodiment, an input generated by the informed advisor may provide more information about the human subject, may confirm a treatment identified within the conditional status 148, and/or may confirm or deny a disease identified within a conditional status 148. Computing device 104 updates a conditional status utilizing input generated by an informed advisor.

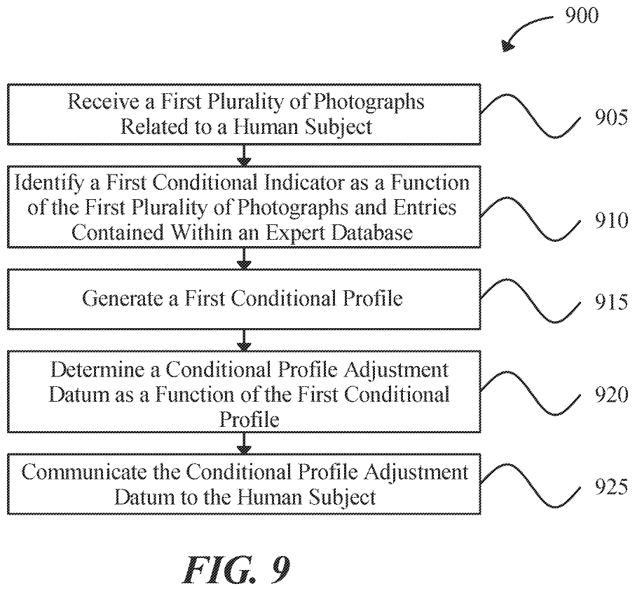

Referring now to FIG. 9, an exemplary embodiment of a method 900 of determining a conditional profile adjustment datum is illustrated. One or more steps if method 900 may be implemented, without limitation, as described with reference to other figures. One or more steps of method 900 may be implemented, without limitation, using at least a processor.

Still referring to FIG. 9, in some embodiments, method 900 may include receiving a first plurality of photographs related to a human subject 905. In some embodiments, the first plurality of photographs is received from a computing device associated with a social media site.

Still referring to FIG. 9, in some embodiments, method 900 may include identifying a first conditional indicator as a function of the first plurality of photographs and entries contained within an expert database 910. In some embodiments, the first conditional indicator is identified as a function of metadata associated with a photograph of the first plurality of photographs.

Still referring to FIG. 9, in some embodiments, method 900 may include generating a first conditional profile 915. In some embodiments, a first conditional profile may be generated by training a classifier on a training dataset including a plurality of example conditional indicators as inputs correlated to a plurality of example conditional profiles as outputs; and generating the first conditional profile as a function of the first conditional indicator using the trained classifier.

Still referring to FIG. 9, in some embodiments, method 900 may include determining a conditional profile adjustment datum as a function of the first conditional profile 920.

Still referring to FIG. 9, in some embodiments, method 900 may include communicating the conditional profile adjustment datum to the human subject 925.

Still referring to FIG. 9, in some embodiments, method 900 may further include communicating a feedback prompt to human subject; and receiving feedback from the human subject. In some embodiments, method 900 may further include receiving a second plurality of photographs related to the human subject; identifying a second conditional indicator as a function of the second plurality of photographs and entries contained within the expert database; generating a second conditional profile as a function of the second conditional indicator using the trained classifier; and determining a profile velocity datum as a function of a difference between the first conditional profile and the second conditional profile. In some embodiments, method 900 may further include communicating to the human subject a medical professional identifier. In some embodiments, method 900 may further include determining a conditional status of the human subject as a function of the first conditional profile, wherein the conditional profile adjustment datum identifies a therapy associated with the conditional status. In some embodiments, method 900 may further include displaying to the human subject a visual element as a function of the therapy associated with the conditional status. In some embodiments, method 900 may further include communicating to the human subject identifying information of an entity providing the therapy. In some embodiments, method 900 may further include prompting the human subject to input a photograph.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

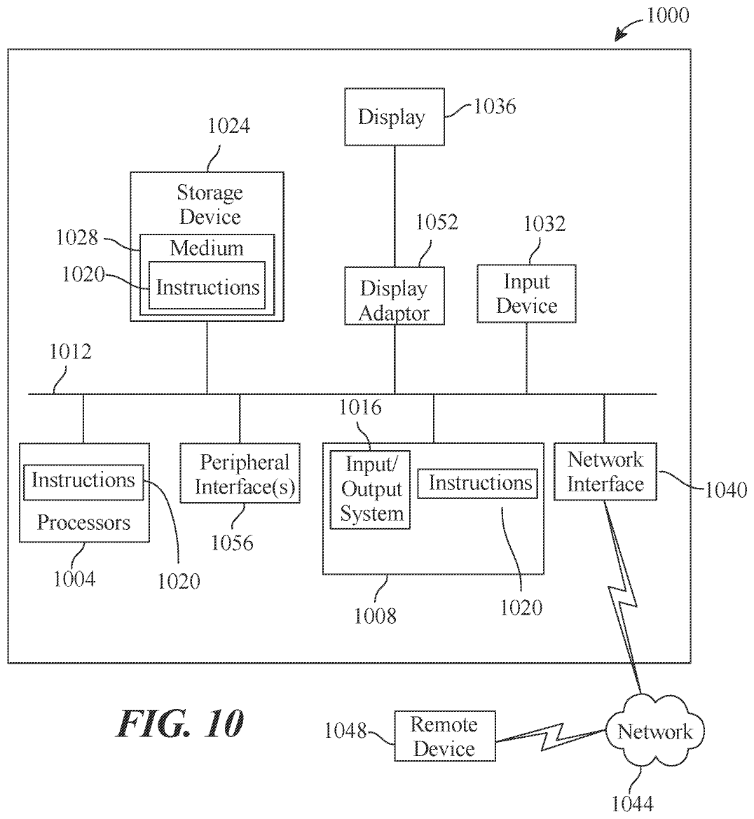

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for determining a conditional profile adjustment datum, the apparatus comprising:
at least a processor; and
a memory connectively connected to the at least a processor, the memory containing instructions configuring the at least a processor to:
receive a first plurality of photographs related to a human subject;
identify a first conditional indicator as a function of the first plurality of photographs and entries contained within an expert database;
generate a first conditional profile by:
training a classifier on a training dataset including a plurality of example conditional indicators as inputs correlated to a plurality of example conditional profiles as outputs; and
generating the first conditional profile as a function of the first conditional indicator using the trained classifier;
determine a conditional profile adjustment datum as a function of the first conditional profile; and
communicate the conditional profile adjustment datum to the human subject.

2. The apparatus of claim 1, wherein the memory contains instructions configuring the at least processor to:
communicate a feedback prompt to human subject; and
receive feedback from the human subject.

3. The apparatus of claim 1, wherein the memory contains instructions configuring the at least processor to:
receive a second plurality of photographs related to the human subject;
identify a second conditional indicator as a function of the second plurality of photographs and entries contained within the expert database;
generate a second conditional profile as a function of the second conditional indicator using the trained classifier; and
determine a profile velocity datum by comparing the second conditional profile with the first conditional profile.

4. The apparatus of claim 1, wherein the memory contains instructions configuring the at least processor to communicate to the human subject a medical professional identifier.

5. The apparatus of claim 1, wherein the memory contains instructions configuring the at least processor to determine a conditional status of the human subject as a function of the first conditional profile, wherein the conditional profile adjustment datum identifies a therapy associated with the conditional status.

6. The apparatus of claim 5, wherein the memory contains instructions configuring the at least processor to display to the human subject a visual element as a function of the therapy associated with the conditional status.

7. The apparatus of claim 5, wherein the memory contains instructions configuring the at least processor to communicate to the human subject identity information of an entity providing the therapy.

8. The apparatus of claim 1, wherein the first plurality of photographs is received from a computing device associated with a social networking platform.

9. The apparatus of claim 1, wherein the first plurality of photographs is received from a computing device associated with a metaverse.

10. The apparatus of claim 1, wherein the first conditional indicator is identified as a function of metadata associated with the first plurality of photographs.

11. A method of determining a conditional profile adjustment datum, the method comprising:
using at least a processor, receiving a first plurality of photographs related to a human subject;
using the at least a processor, identifying a first conditional indicator as a function of the first plurality of photographs and entries contained within an expert database;
using the at least a processor, generating a first conditional profile by:
training a classifier on a training dataset including a plurality of example conditional indicators as inputs correlated to a plurality of example conditional profiles as outputs; and
generating the first conditional profile as a function of the first conditional indicator using the trained classifier;
using the at least a processor, determining a conditional profile adjustment datum as a function of the first conditional profile; and
using the at least a processor, communicating the conditional profile adjustment datum to the human subject.

12. The method of claim 11, wherein the method further comprises:
using the at least a processor, communicating a feedback prompt to human subject; and
using the at least a processor, receiving feedback from the human subject.

13. The method of claim 11, wherein the method further comprises:
using the at least a processor, receiving a second plurality of photographs related to the human subject;
using the at least a processor, identifying a second conditional indicator as a function of the second plurality of photographs and entries contained within the expert database;
using the at least a processor, generating a second conditional profile as a function of the second conditional indicator using the trained classifier; and
using the at least a processor, determining a profile velocity datum by comparing the second conditional profile with the first conditional profile.

14. The method of claim 11, wherein the method further comprises, using the at least a processor, communicating to the human subject a medical professional identifier.

15. The method of claim 11, wherein the method further comprises, using the at least a processor, determining a conditional status of the human subject as a function of the first conditional profile, wherein the conditional profile adjustment datum identifies a therapy associated with the conditional status.

16. The method of claim 15, wherein the method further comprises, using the at least a processor, displaying to the human subject a visual element as a function of the therapy associated with the conditional status.

17. The method of claim 15, wherein the method further comprises, using the at least a processor, communicating to the human subject identity information of an entity providing the therapy.

18. The method of claim 11, wherein the first plurality of photographs is received from a computing device associated with a social media site.

19. The method of claim 11, wherein the first plurality of photographs is received from a computing device associated with a metaverse.

20. The method of claim 11, wherein the first conditional indicator is identified as a function of metadata associated with a photograph of the first plurality of photographs.
